(19) United States
(12) Patent Application Publication
(10) Pub. No.: US 2012/0158808 A1
(43) Pub. Date: Jun. 21, 2012

(54) METHOD FOR OPTIMIZATION OF MEASUREMENT STANDARD AND INDUSTRIAL ENGINEERING CALCULATION METHOD USING THE SAME

(75) Inventor: Dong-Bong Yang, Seoul (KR)

(73) Assignee: E.P. Lab. CO., LTD., Seoul (KR)

(21) Appl. No.: 12/280,344

(22) PCT Filed: Feb. 27, 2006
(86) PCT No.: PCT/KR2006/000674

§ 371 Date: Aug. 21, 2008

(51) Int. Cl. G06F 7/00

(52) U.S. Cl. 708/206

(57) ABSTRACT

Measurement standards are optimized via the unification of measurement unit of physical properties into dimensionless numbers. There is an invariance equations governing natural phenomena, and <data> is never abstract and inevitably linked to <physical representation>. All measurement units (physical quantities) into dimensionless numbers with the minimum natural (boundary) condition are unified based on nature's invariance equations, setting up the new measurement standard and optimizing measurement and calculation. In the expression of physical quantities, numbers representing quantity and units are combined. Based on nature's invariance equations, the minimum object-based numbers related to all measurement units are discovered. Using these numbers, all measurement units including basic units can be converted into the system of dimensionless numbers. As all measurement units are expressed as numbers without any dimension, compatibility of measurement units is in place. Thus, the barriers between different areas of academia are crossed over and synergistic effects are reaped.

### TECHNICAL FIELD

The present invention relates to a method of unifying measurement units of physical properties into dimensionless numbers and optimizing measurement standard, a concerned industrial engineering calculation method, a quantitative and qualitative translation of dimensionless numbers related to natural phenomena, computer operating system and computer-readable record medium based on the foregoing programming.

### BACKGROUND ART

The metric system, i.e. the SI base units, is an internationally agreed standard unit, which is currently used by approximately 7 billion people across the world. Words related to quantity in natural science are clearly and exactly defined. It is intended to avoid any confusion with the meaning of the words in daily lives.

Physical properties can be theoretically defined as the smallest unit that can be mathematically computed. In effect, they are represented as physical quantities, i.e., measurement units.

Physical laws of nature represent the mutual relations of physical quantities such as length, time, force, energy, etc. Therefore, physics inevitably requires the capacity to exactly define and precisely measure such quantities.

Measurement of a certain physical quantity refers to comparison of the quantity with the exactly defined unit quantity. Measurement is aimed to determine the quantity of the physical property via comparison with the selected standard unit. In other words, comparison with the standard unit constitutes calculation whereas measurement is the representation of the resulting value as the quantity along with a unit.

In 1960, General Conference of Weights and Measures adopted the system of unit that every member nation could conveniently use, and named the system as the International System of Units, i.e., <Metric system>. And the international body defined 7 base units such as length (m), mass (kg), time (s), electric current (A), temperature (K), quantity of matter (mol) and luminosity (cd), 2 supplementary units of plane angle (rad) and solid angle (Sr), and 27 derived units (frequency, force, pressure, capacitance, specific heat and so on). And SI units were further refined in 1991.

As such, <Metric system> was needed due to the advancement of scientific technology and the growing demand for international compatibility of standards. For example, there are 1,500 factories worldwide for Boeing 747 Jumbo jets, which require approximately 4.5 million standard parts and components. And each part and component is requested to be precise at the level of 1/10,000 mm. In order to build an airplane out of parts and components from all over the world, exact global standards of length, etc. are needed above anything else.

However, base units of <Metric system> cannot be compared with each other and they work independently. Accordingly, physical laws explaining the relationships among units are highly complex and difficult to understand. Human beings hardly challenge that 7 base SI units cannot be compared among each other (e.g. incomparability of mass and time, incomparability of length and temperature, etc.) up till now.

Time, which is one of physical quantities, is measured by regularly repeating events. If there is no repeating phenomenon in the world, time cannot be defined. Repeating phenomena refer to sunrise & sunset, swings, heartbeats and any other repeating events.

International unit of time is 1 second. Initially, 1 second was defined as the time that a pendulum of 1-meter length swung from one end to the other in the age of Napoleon. That is, 1 meter was defined first to identify 1 second. The problem was that 1 second defined as such had different values depending on the location of measurement on the earth. Of course, the discrepancy depending upon the location of the measurement was minute. Yet, more exact unit of time was needed more than ever due to the growing volume of barter trades and sea traffic.

Therefore, it was decided that 1 second would be defined based on the earth's rotation, rather than a pendulum. That is, 1 second was defined as 1/86,400 of the interval of the two successive returns of the Sun to the peak. This value was consistent with that measured from a pendulum within the range of standard deviation at the time. 1 second defined herein was in use until the year 1967.

However, the society got more precise and science advanced to the point that 1/86,400 of a day was no longer sufficiently precise. In effect, a day got longer by 0.002 second every day due to the slowing rotation of the earth. Such a gap may be trivial in our daily lives. But, the inaccuracy of 0.002 second per day is unbearable in the areas of telecommunications or precision control. That's why physicists started to work on the atom-driven clock from 1960s.

The international standard of 1 second currently in use is 9,192,631,770 times the oscillation of Cs-133 atom. Here, the number 9,192,631,770 is derived so as to match the previously used time interval of 1 second.

The international unit of length is 1 meter. In the age of Napoleon, 1 meter was defined as one ten-millionth of the distance from the equator to the north pole (the meridian). Based on the definition, 1 meter-bar was produced and used as the prototype of length, which was called meter prototype. A total of 30 bars in H shape were produced, the alloy of platinum with ten percent iridium so that they wouldn't be easily deformed. One of the 30 bars was set as the prototype meter and kept on the outskirts of Paris, France, and the rest of them were distributed to countries around the globe as the supplementary meter standard. Later, when the precise distance from the north pole to the equator was measured and was divided by 10 million, the value was found to be longer than the prototype meter by 0.18 mm. In addition, the length of the metal meter prototype tended to change depending upon temperature.

Under the circumstances, scientists pursued the standard of 1 meter that would never change and they came to think of the standard of length based on the attribute of atom, which was also used for time standard. Therefore, “the International conference on length and mass” held in 1960 newly defined that 1 meter was 1,650,763.73 wavelengths in vacuum of the orange-colored radiation of the krypton-86 atom (⁸⁶Kr).

Of course, the foregoing definition was established to be consistent with 1 meter that had been used within the range of the standard deviation. Despite Krypton being a rare atom, it was satisfying to draw up the standard of length based on Krypton, which would never change.

However, this was never enough. In terms of the significant figures, the exactness of 1 meter (relative error) defined via Krypton was about one millionth of that defined through Cesium atom clock. What undermines the exactness in measuring the velocity of light traveling in vacuum is length (distance), rather than time.

The light speed in vacuum is measured as c=299,792,458 m/s. And if length can be more exactly measured, we can get the more precise measurement. Therefore, in 1983, 1 meter was defined based on the speed of light as follows; “The meter is the length of the path traveled by light in vacuum during a time interval of 1/299792458 of a second.”

The yearning for the prototype is even more so for 1 kg, i.e., the international standard of mass. If space and time are considered as the background of an event, matters will be the main player of an event. And the most significant component to determine the motion of a matter is mass.

The international unit of mass is 1 kg. Initially, 1 kg was defined as the mass of water in regular hexahedron with one side being 10 cm when pressure was 1 pressure and temperature was 3.945° C. This definition sounds okay since water can be obtained everywhere. However, as the volume of water is easily affected by temperature, the temperature of 3.945° C. should be maintained at all times. And the effort is needed to precisely control the container, water vaporization, waves, etc.

Therefore, the primary mass prototype was produced so as to define mass as 1 kg. This is called kilogram prototype, which is an alloy of platinum and iridium. The cylinder shape prototype is 3.9 cm in diameter and 3.9 cm in height and is kept on the outskirts of Paris.

And other countries produced supplementary mass prototype with the exactly same mass and used the prototype as their standard. Therefore, the preciseness of 1 kg that we use now is limited by the exactness of the measuring scale.

Currently, countries send their own supplementary mass prototypes to Paris, France, to see if there's any change in mass compared to the primary mass prototype. This is definitely a nuisance. However, there's no atomic standard that is more precise than this method, unlike definitions of 1 second and 1 meter.

The method of using mass prototype does not suit the precise world that we live in. Especially, it was found that mass changed by approximately 1 μg per annum from the three rounds of tests over 1 century since the introduction of the primary mass prototype in 1889. Unlike all SI units based on light or atoms, the unit of mass only is determined by the prototype that human beings set up at their discretion.

At present, values of physical quantities based on the foregoing <Metric system> are optimized via conversion of the observation of the specific natural state into numeric values. This approach is based on the empirical laws or statistics method over a long period of time and is diversely adopted in genetic engineering, biology, macroeconomics, complex system of physics, etc.

However, the bottom line is that simple conversion of natural state itself, macro-system or micro-system, into numeric values is considered impossible. This means that we have not established the scientific theory to prove the relationships among specific natural states theoretically up till now.

Optimization via simple and quantitative conversion into values is not a viable option for matters with different dimensions since they cannot be put to direct computation or comparative analysis among themselves in reality. Even through the statistical methods accumulated over a long period of time and various highly sophisticated error adjustment mechanism, minute errors will get piled on and this will denote a fatal defect in the world of modern science where preciseness is essential. This means that there is the inherent structural limitation in addition to the limitation of statistical approach.

Accordingly, the direct qualitative translation of the matter subject to comparative analysis is almost impossible and the capacity of prediction and control, i.e. the useful goals of scientific theories, is significantly undermined.

Setting up the <standard> for the measurement of physical quantities has a huge impact across the areas of industrial technologies, regardless of whether it is an international standard or a domestic standard. How a standard of an area is established has dramatically changed the dynamics of the area's industrial technology in many cases.

The SI units, i.e. <Metric system>, have resulted from hundreds of small and large international conferences, reviews and discussions among the world-renowned scholars in all areas of natural science. Even so, current <Metric system> is far from complete and universal. All the 7 SI base units are independent and cannot be compared among each other. Incomparability among base units represents incompatibility, which leads to functional limitation of computers, the main tool of computation and measurement.

To further explain, computability in computers denotes that matters being calculated are logical propositions that allow strict logical description. The logical proposition is what pure mathematical theories are about and it refers to physical properties in the field of science.

Physical properties are defined as the smallest units that can be mathematically calculated from the purely theoretical perspective. We can take physical quantities that human beings defined to allow accurate communications for an example and this can be considered as physical property that is commonly agreed upon. As mathematical computation can be done only among physical quantities with the same dimension, it is notable that calculations of computer are not without the aforementioned limitation.

The unit of kilogram, kg, can be computed with kg alone, yet kg and temperature (K) cannot be computed with each other. We can say that it is impossible to quantitatively or qualitatively infer the logical relations among different physical properties (specifically, the physical quantity as the logical representation, which has semantically different dimension from the physical properties of mass and temperature.)

If the mutual relations among different physical properties cannot be derived, computer operation and control cannot be done, and, naturally, calculation of different physical properties is not possible in computers.

Since calculations in computer are within the boundary of simple arithmetic calculation, logical derivation is needed for the qualitative interpretation of calculation results. And this is the final output of computer calculations, i.e., what computer is designed to deliver. A series of calculations in computers result from the engineering system based on the control of simple electric signals. What is notable here is that computer calculations and the concerned results can only be derived when programs are coded externally in accordance with the logic of computer language, which is a logical language that people defined.

In other words, computers, i.e. machines, do not cognitively judge or execute certain cognitive activities. Rather, human beings insert specific symbols with the syntax that is required for input while computers mechanically understand and derive specific symbols as the output according to the previously input logical structures or rules.

Here, high-level languages are the examples of the previously input symbols and computers read and translate the input in accordance with the agreed rules. It is noteworthy that computers have the function of the simply quantitative calculation as well as the function of the qualitative logical reasoning as computer languages have syntax.

Computer languages generally used for entries into computers are the high-level languages and programmers actually use structured English rather than standard English. And the structured English has specific syntax so as to allow strict logical description and reasoning.

All computer languages are based on strict syntax. Broadly speaking, computer languages can be construed as committing to the physical properties as per a certain patterns of nature. In this sense, computer languages are similar to physical quantities, which are the basic terms to extract the specific physical structure from natural science.

In effect, computer scientists are making efforts to derive the universal syntax composed of the minimum number of parameters, in order to produce the minimum program of computer languages.

Linguists assume that grammars of all the different languages in the world commonly contain the parameter as the core component and are trying to identify the parameter. Likewise, if we can translate or identify the values of parameters of computer languages, it is possible to concoct diverse languages out of several simple parameters. And the invariant structure, which is the common to all languages, can be identified.

If so, ideal computer program languages can be established only via the minimum components. Computer calculation will be made extremely simple and systems can be built without bugs or errors.

Let's remember that natural science expresses and translates diverse natural phenomena with physical quantities, i.e., the logical representation in different semantic dimensions. Expression via physical quantities denotes that natural phenomena are represented via physical equations that we are familiar with. It is as if natural phenomena are manifested in the proper algorithms that anyone can recognize. This is made possible because the physical properties of physical phenomena concerning each and every natural phenomenon are designated and indicated as previously agreed symbols (physical quantities).

Agreement upon the definition of physical properties is essential in order to obtain exactness and comparability of measurement in reality. The composition and syntax of computer languages, i.e. the tool of computer input, are closely related to the commonly agreed definition of physical properties, given that modern science extracts the required accurate data from computers.

Unfortunately, current computer language structure is made of discretionary syntax and it has nothing to do with the commonly defined physical properties. Therefore, computer operation is one thing and reasoning of operation result is another.

In other words, in order for an ordinary computer language to produce the output serving various purposes in accordance with the complex logic in terms of operation and control, input gets inevitably difficult and complex. This is the inherent limitation of present computer languages.

The foremost issue in modern computer science or engineering originates from the highly difficult and complicated input method of computer languages to get the expected output. Especially when dimensions are complex in calculation, logic circuits of computer operation and control get equally complex. It is particularly so when the errors concerning inputs that have been empirically obtained (statistical or structural errors) get accumulated. In this case, we are faced with the fundamental limitation, despite that the computers are utilized for exact or precise calculation. And this is why there are many errors and bugs in computer calculations.

To cope with the limitation arising from the complex logic circuits and to obtain the exact output from computer calculations, a simple technical approach of enhancing the hardware such as operation speed and memory capacity is fundamentally flawed since this originates from lacking understanding of the in-depth and structural concepts of the physical properties and common definition thereof.

### DISCLOSURE OF INVENTION

The technical object that the present invention is aimed to address is, to provide a method for direct calculation among physical quantities and the sets of physical quantities of different dimensions that have deemed impossible by establishing the measurement standard for all physical properties subject to measurement and optimizing calculation and measurement.

Another technical object that the present invention is aimed to tackle is to offer a method of converting the physical properties that are measured or calculated into dimensionless numbers and of handling operations of industrial engineering, ultimately enhancing the exactness and preciseness of industrial engineering calculation (measurement) and control.

Also, the present invention is aiming at providing a method of the quantitative calculation and the qualitative translation of physical properties that are represented in dimensionless numbers.

And the present invention is designed to offer a record medium of the quantized numbers without dimensions to support the quantitative calculation and the qualitative translation of the physical properties that are represented in dimensionless numbers.

The present invention is intended to program the foregoing methods and provide them in the computer-readable medium.

Another technical object that the present invention is aimed to address is to offer computer O/S where numbers themselves become equations=algorithms=computer programming language=computer programs.

Based on Zero Zone Theory, the present invention unifies all measurement units (physical quantities, etc.) into dimensionless numbers, establishes the new measurement standard and optimizes calculation and measurement. In so doing, it is now possible to do calculations among physical quantities and the sets of physical quantities, which has been deemed impossible up till now.

The inventor did the in-depth analysis of the meaning of numbers and the relations among various physical constants and properties of elementary particles (mass, etc.) that have been experimentally measured and he intuitively extracted invariance equations. Based on the comparative analysis of the physically defined 4 physical quantities (speed of light c, permittivity ε0, permeability μ0 and gravitation acceleration g), natural logarithm e, number pi, extreme and mean ratio, etc. that always emerge in nature's fundamental representation, the inventor found that there were regular patterns and invariance equations behind various natural phenomena.

For reference, the theory about invariance equations of nature was mainly discussed in Platonism, formalism, constructivism and so on. And it is well known that the theory of invariance equations has been at the center of controversies as it serves as the foundation for the diversified translation theories regarding mathematical physics.

And the inventor identified the relations among fundamental physical quantities based on the intuitively derived invariance equations and discovered that physical quantities could be converted to absolute numeric values without dimensions through renormalization, which set speed of light as “1”. In so doing, the inventor found that all physical quantities were equivalent, in addition to energy and mass.

Furthermore, the inventor used the invariance equations to extract the translation definition of fundamental physical quantities and the quantitative relations among numeric values and analyzed physical quantities that emerge at the top layer of the hierarchy in a complicated manner, based on equations of the unique frequency patterns of physical quantities and their numeric values.

The values of the physical quantities at the top level of hierarchy, which are obtained from calculation, are validated if they are consistent with experimental results. In so doing, it is possible to validate the defined translation of fundamental physical quantities, relations among quantitative values, equations of the unique frequency patterns of fundamental physical quantities and their numeric values.

Through the foregoing validation, it is found that the fundamental physical quantities and the physical quantities at the top of the hierarchy do continuously maintain the integrity. And it becomes obvious why the physical quantities at the bottom layer of the hierarchy have the particular unique frequencies (dimensionless numbers).

Invariance equations utilized in the validation process are confirmed to offer the profound implications to the phenomena that appear in nature. In other words, the verification mechanism based on the invariance equations does identify major physical quantities at the bottom layer of the hierarchy of natural phenomena while maintaining the integrity with the physical quantities at the top of the hierarchy. From this hierarchal structure, now natural phenomena finally start to reveal their true identity.

In addition, the repeated analysis has been done on the physical quantities at the top layer of the hierarchy while the physical quantities at the bottom, i.e. the components of the higher-level quantities, have been used exponentially. In so doing, various equations (local gauge invariance, etc.) can be obtained from the invariance equations themselves, reinforcing consistency, clarity and reliability of the numeric values of the physical quantities at the bottom layer of the hierarchy.

The aforementioned process involves the uncertainty principle, which is one of the main paradigms of quantum physics toady. Here, measurement that is inseparable from intuition or cognition is also involved. And via highly complex phased derivation process, this is when the relations among the three most essential physical constants such as Newton's gravitational constant, Einstein's constant (speed of light) and Planck's Planck constant are finally interpreted and manifested.

Based on the foregoing process, the inventor could overcome the limitation of the mathematical proof and the proposition of impossibility of common definition. And the inventor could also reestablish the true meaning and values of physical quantities and physical constants, which have been considered as simple tools of physics.

The present invention presents the following technological concept that produces the industrial utility based on <Zero Zone Theory>.

In one aspect of the present invention, there is provided a method of operating the industrial engineering equations related to the industrial engineering measurement or control, which includes the step of converting physical quantities of different dimensions and units into dimensionless numbers based on Zero Zone code, substituting them into industrial engineering equations for operations.

In another aspect of the present invention, there is also provided a method of industrial engineering operation, which includes the step of loading industrial engineering equations; getting input of physical quantities with units regarding variables contained in industrial engineering equations; converting the previously input units of physical quantities into dimensionless numbers based on Zero Zone code, i.e., making physical quantities dimension-less; and inserting the foregoing dimensionless physical quantity into the concerned industrial engineering equations and executing the operation.

In still another aspect of the present invention, there is still provided a industrial engineering method that includes the step of loading the industrial engineering equations; getting input of physical quantities with units regarding variables contained in industrial engineering equations; and inserting the foregoing dimensionless physical quantities into the concerned industrial engineering equations and executing the operation.

According to the present invention, the aforementioned physical quantity is represented as the standard unit based on <Metric system>. And the process of converting physical quantity into a dimensionless number is the effort of substituting each unit contained in the foregoing standard units for the corresponding Zero Zone code so as to convert the physical quantity into the dimensionless number.

According to the present invention, the conversion of physical quantity into the dimensionless number includes the step of converting the unit of the concerned physical quantity into the standard unit of <Metric system>; and substituting each unit contained in the standard unit with the corresponding Zero Zone code, i.e. converting the physical quantity into dimensionless number.

The present invention may further include the step of extracting output of the industrial engineering operation as dimensionless numbers. In addition, the dimensionless number as the output of the foregoing industrial engineering operation may be converted back to physical quantities and output is produced accordingly.

In the present invention, in case equations for the industrial engineering operation include physical constants, the aforementioned physical constants preferably have dimensionless numbers as per the theorem of fundamental dimension.

According to the present invention, the industrial engineering method may further include the steps of quantizing multiple dynamic equations that comply with Zero Zone theory and accessing the Standard compilation code, which stores the cross-reference structure of quantized dimensionless numbers and the corresponding dynamic equations; and using the dimensionless numbers produced as the result of the industrial engineering operation for comparison with the dimensionless numbers of the foregoing Standard compilation code so as to identify the exact dimensionless number or that with the smallest error and extracting the dynamic equation equivalent to the selected dimensionless number for output.

In one aspect of the present invention, there is provided a method of building the standard compilation code, which includes the steps of: (a) getting input of dimensionless number as per the theorem of the fundamental dimension in Zero Zone theory and the corresponding dynamic equation of nature; (b) conducting mathematical operation with regular patterns of the aforementioned dimensionless numbers and quantizing the dimensionless numbers into multiple numbers; (c) storing the quantized numbers, the mathematical operation method deployed to the extraction of the quantized numbers and the reference codes of nature's dynamic equations in a way that cross-reference is allowed; and (d) the repeated execution of the steps (a) to (c), with respect to multiple dimensionless numbers and the corresponding dynamic equations.;

Preferably, the present invention includes the steps of getting input of multiple dimensionless numbers as per the theorem of fundamental dimension under Zero Zone theory and of multiple dynamic equations corresponding to each dimensionless numbers; and additionally permuting and combining the entered multiple dimensionless numbers and executing the pre-defined operators for the dimensionless numbers. And, the foregoing steps (b) and (c) are executed on dimensionless numbers resulting from mathematical operations and the corresponding dynamic equations.

In another aspect of the present invention, there is also provided a method of building the standard compilation code, which includes the steps of: (a) getting input of dimensionless number as per the theorem of fundamental dimension in Zero Zone theory and the corresponding dynamic equation of nature; (b) executing mathematical operation with regular patterns of the aforementioned dimensionless numbers and quantizing the dimensionless numbers into multiple numbers; (c) storing the quantized numbers, the mathematical operation method for extracting the quantized numbers and the reference codes of the nature's dynamic equations in a way that cross-reference is allowed; and (d) repeating the steps (a) to (c), with respect to multiple dimensionless numbers and the corresponding dynamic equations.

Preferably, the present invention additionally includes the steps of getting input of multiple dimensionless numbers as per the theorem of fundamental dimension under Zero Zone theory and of multiple dynamic equations corresponding to each dimensionless numbers; and permuting and combining the entered multiple dimensionless numbers and executing the pre-defined operators for the dimensionless numbers, wherein the steps (b) and (c) are executed on dimensionless numbers resulting from mathematical operations and the corresponding dynamic equations.

In another aspect of the present invention, there is also provided a method of building Standard compilation code, which includes the steps of: (a) getting input of dimensionless number as per the theorem of fundamental dimension in Zero Zone theory and the corresponding dynamic equation of nature; (b) executing mathematical operation with regular patterns of the aforementioned dimensionless numbers and quantizing the dimensionless numbers into multiple numbers; (c) storing the quantized numbers, the mathematical operation method for extracting the quantized numbers and the reference codes of the nature's dynamic equations in a way that cross-reference is allowed; and (d) repeating the steps (a) to (c), with respect to multiple dimensionless numbers and the corresponding dynamic equations.

Preferably, the present invention additionally includes the steps of: getting input of multiple dimensionless numbers as per the theorem of fundamental dimension under Zero Zone theory and of multiple dynamic equations corresponding to each dimensionless numbers; and permuting and combining the entered multiple dimensionless numbers and executing the pre-defined operators for the dimensionless numbers, wherein the steps (b) and (c) are executed on dimensionless numbers resulting from mathematical operations and the corresponding dynamic equations.

In one aspect of the present invention, there is also provided a record medium, which includes the dimensionless numbers that are generated from the quantization of multiple dimensionless numbers as per the theorem of fundamental dimension under Zero Zone theory and the corresponding dynamic formulas in a way that cross-reference is allowed.

The quantitative and the qualitative translation method of dimensionless numbers related to natural phenomena based on such record medium includes the steps of: (a) getting input of physical quantity related to natural phenomena as dimensionless number; (b) comparing the quantized dimensionless numbers stored in the record medium with the input dimensionless numbers to identify the most exact quantized dimensionless number or that with the smallest error; and (c) reading and generating the output of the dynamic equations of nature corresponding to the concerned dimensionless number.

Preferably, the present invention may further include the steps of: (d) designating the foregoing errors as the search keys; (e) comparing the quantized dimensionless numbers stored in the foregoing record medium to identify the most exact quantized dimensionless number or that with the smallest error; and (f) reading the dynamic equation corresponding to the concerned dimensionless number and combining it with the dynamic equation extracted from the step (c) to produce the output accordingly.

In another aspect of the present invention, the record medium stores the multiple quantized dimensionless numbers as per the theorem of fundamental dimension under Zero Zone theory, reference codes of dynamic equations of nature that match the dimensionless numbers and the mathematical operators establishing the equivalence between the dimensionless number and the dynamic equations of nature so as to allow the cross-reference among them.

The quantitative and the qualitative translation method of dimensionless numbers related to natural phenomena based on such a record medium includes the steps of: (a) getting input of the physical quantity related to natural phenomena as dimensionless number; (b) comparing the quantized dimensionless numbers stored in the foregoing record medium with the entered dimensionless numbers to identify the most exact quantized dimensionless number or that with the smallest error; and (c) reading the reference code of dynamic equation of nature equivalent to the identified dimensionless numbers and the mathematical operators from the aforementioned record medium and of executing the mathematical operations on the mathematical operator to produce output accordingly.

Preferably, the present invention may further include the steps of: (d) designating the foregoing errors as the search keys; (e) comparing the quantized dimensionless numbers stored in the foregoing record medium to identify the most exact quantized dimensionless number or that with the smallest error; (f) reading the dynamic equations corresponding to the concerned dimensionless number and the mathematical operators from the record medium and executing the mathematical operators on the reference code of the dynamic equations; and (g) combining the reference code of the dynamic equations subject to the mathematical operators in the step (c) and that of the dynamic equations subject to the mathematical operators in the step (f) to produce output accordingly.

In another aspect of the present invention, the record medium stores the multiple quantized dimensionless numbers as per the theorem of fundamental dimension under Zero Zone theory, dynamic equations of nature that correspond to the dimensionless numbers and the mathematical operators establishing the equivalence between the dimensionless number and the dynamic equations of nature in a way that cross-reference is allowed.

The quantitative and the qualitative translation method of dimensionless numbers related to natural phenomena based on such a record medium includes the steps of: (a) getting input of the physical quantity related to natural phenomena as dimensionless number; (b) comparing the quantized dimensionless numbers stored in the foregoing record medium with the entered dimensionless numbers to identify the most exact quantized dimensionless number or that with the smallest error; and (c) reading dynamic equations of nature corresponding to the chosen dimensionless numbers and the mathematical operators from the aforementioned record medium and executing the mathematical operations for output.

Preferably, the present invention may further include the steps of: (d) designating the foregoing errors as the search keys; (e) comparing the quantized dimensionless numbers stored in the foregoing record medium to identify the most exact quantized dimensionless number or that with the smallest error; (f) reading dynamic equations corresponding to the concerned dimensionless number and the mathematical operators from the record medium and executing the mathematical operators on the dynamic equations of nature; and (g) combining the dynamic equations subject to the mathematical operators in the step (c) and that of the dynamic equations subject to the mathematical operators in the step (f) to produce output accordingly.

The present invention described herein is designed for coding via the programming language and storing it in a computer-readable record medium. As for the record medium, there are ROM (Read Only Memory), RAM (Random Access Memory), CD-ROM (Compact Disk Read Only Memory), DVD-ROM (Digital Video Disk Read Only Memory), magnetic tape, floppy disk, optical data storage, flash memory and so on. In addition, such record medium is stored in the networked computer system and computer-readable codes can be stored and executed in a distributed manner.

### BRIEF DESCRIPTION OF THE DRAWINGS

The accompanying drawings integrated herein presents preferable examples illustrating how the present invention can be implemented. This will explain the principle of the invention, along with the detailed explanation of the present invention.

The accompanying drawings just illustrate preferred examples of the present invention and contribute to the better understanding of the technical concepts behind the present invention, in addition to the following detailed explanation. Accordingly, the present invention should not be translated as being confined to what is indicated in the drawings.

FIGS. 1 and 2 are tables indicating the relations between SI and units as per Standard compilation code (Zero Zone code).

FIG. 3 is a table showing the quantized numbers (or, it can be seen as Standard compilation code or Zero Zone code) with respect to the SI base units.

FIGS. 4 to 10 are tables showing the detailed definition and the equations of quantization of each base SI unit.

FIGS. 11 to 19 are tables indicating major elementary particles and the quantized numbers (Standard compilation code or Zero Zone code) of physical constants.

FIG. 20 is a flowchart illustrating the process of building Standard compilation code based on the expanded concept of database.

FIG. 21 is a flowchart illustrating the process of translating the dimensionless numbers related to natural phenomena in the quantitative and the qualitative manner, based on Standard compilation code DB.

### BEST MODES FOR CARRYING OUT THE INVENTION

The present invention originates from the inventor's<Zero Zone theory>. Natural phenomena such as properties of elementary particles, interaction, etc. have been known to have special boundaries or divisions that cannot be crossed over up till now. <Zero Zone theory> proves that there is no such barrier among natural phenomena.

<Zero Zone theory> contains the theorem of fundamental dimensions that converts 7 fundamental physical quantities and all derived physical quantities into the same dimension. Here, conversion refers to the mathematical rule and function to transform the object of the mathematical operation into something else.

⊚ The Theorem of Fundamental Dimensions as Per Zero Zone Theory

I. Defining 3 Phases in Basic Dimensions

<Zero Zone theory> unifies all physical quantities into the same dimension of energy through transformation and sets “light” as the smallest energy quantum unit. Therefore, “light” becomes the definition, the property and space-time itself, which is the starting axiom of existence of all theories. And it is also the starting point of all language letters, i.e., the tool of communications.

<Zero Zone theory> explains how everything in nature emerges in 3 phases.

The first phase is defined to be the <Stage of existence>.

The second phase is the <Stage of symbol>, which follows the <Stage of existence> and precedes the so-called <Stage of reality>, i.e., the phase of reality. The proposition about truth and falseness is selectively verified in the second phase. When words are spoken, the logical contradiction of duality steps in. And the mathematical axiom or the physical postulate is initiated while the fundamental dimension of physical properties is fixed.

The third phase is the <Stage of reality>, where truth or falseness is selected from the contradiction of duality based on the starting axiom, <Stage of existence> and the stage of selection, <Stage of reality> with conflicts and tension surrounding the validation. This stage mathematically copes with the rule of contradiction and the rule of the excluded middle while involving the uncertainty principle physically so that measurement is interpreted as the result of natural phenomena.

In the stage of fundamental dimension where logical representations with different semantic dimensions converge, all physical quantities across the 3 stages of space-time with different properties come to have one identical dimension. Physically, this represents the invariance principle, which means that physical properties of nature have regular patterns and regular relations, irrespective of space-time. Here, invariance indicates that physical properties or physical laws never change despite any manipulation (transformation or operation) such as the inversion of spatial coordinates, time inversion, charge conjugation, rotation and Lorentz transformation. And invariance principle means that physical properties or laws remain invariant despite any transformation.

“Light” spreads across the space-time of 3 phases with different attributes and it is possible to infer definition, axiom and postulate of the attributes of “light” itself. However, proving the existence of “light” is limited in that light cannot be proven without any contradiction. Also, the definition of light is limited in that it cannot be proven by itself.

After moving from the <Stage of existence> where incompleteness theorem is involved, i.e., definition and proof cannot be done in one formal structure, to the <Stage of reality>, i.e., the stage of the specific activity of measurement, the reality of “light” is translated, measured and validated.

In the <Stage of reality>, the meaning of “light” itself becomes obvious and it is expressed as an individual “photon”. “Light” is basically proven from mathematics perspective. However, “photon” is an existence. And “light” is effectively proven to have mass through experimental measurements. “Photon” becomes an individual physical property that can be mathematically calculated. It is the smallest measurable energy quantum as well as the smallest calculation unit that can be calculated via computers.

When the 3 phases of spec-time are viewed from the perspective of the relationship between elementary particles and numbers, the 1^{st} phase is when the existence, concepts of quantum and complex number of “light” are all simultaneously set up.

The 2^{nd} phase is when neutrinos with both the attributes of the 1^{st} phase and the 3^{rd} phase are generated and where real numbers and imaginary number co-exist. Also, the property of graviton is at work in this phase.

In the 3^{rd} phase, “light” that functions all over the space-time emerges as electron with orientation, that is, the symbol of real world. In other words, electron becomes the messenger of “light” in reality. This is why “light” is emitted at the time of electron's orbital transition via the quantum tunneling in atom. In addition, this is when graviton is measured as the real number in the form of gravitational constant.

When the foregoing space-time concept is reviewed, it is possible to establish an important conceptual framework for the relationships of the duality of matters and non-matters, real numbers and imaginary number, and so on. For instance, based on this conceptual framework, we can actually get near to the qualitative meaning and the quantitative value of imaginary number with respect to real numbers, i.e., the <quantization of imaginary number>.

In <Zero Zone theory>, the quantitative and the qualitative meanings of the fundamental physical quantities and the derived physical quantities are interpreted from the single dimension. Therefore, the unique value of physical quantity (dimensionless number) that is derived herein backs up the reasoning of the being of “light” and the existence of “photon”, regardless of space-time. The unique value and the meaning of the physical quantity can only be obtained when energy conservation law is strictly enforced and satisfied.

The utility and the reliability of reasoning can be proven through specific test results. The truth can be pursued via the mathematical argument. However, physical tests directly verify and complete the utility in reality. The mathematical proof and the physical measurement are necessary and sufficient to explain reality “as it is”.

The mathematical proof is necessary, yet not sufficient at all, in the pursuit of truth. To make up for the necessary condition in effect, direct physical measurement is required. The result of physical measurement can be explained via one <representation> in the world of existence. This is why space-time in the 3^{rd} phase is called the <Stage of reality>.

The unique value of physical quantities that emerge in the <Stage of reality> is harmoniously determined in accordance with the invariance principle with regular patterns. Therefore, it is possible to unify physical quantities into dimensionless numbers if this unique value is set as the basis of actual measurement. Of course, this is based on the assumption that invariance equation is known.

The invariance principle in <Zero Zone theory> is that physical laws represented as invariance equations remain independent of definition and base coordinates.

Let's take electron for an example. The eigen-frequency of electron consists of the combination of specific parameters and this is found to be one of invariance equations. The values of each parameter forming the invariance equation are determined based on the initial condition, rather than being fixed from the beginning. Electron mass (rest mass) actually is determined experimentally, based on the value of parameter (physical quantity) that is arbitrarily set. In other words, the value of parameter is changed once the initial condition is changed. Yet, this does not impact the invariance equation and the eigen-frequency.

This means that the mass of electron is constant even when parameters forming electron, i.e., a physical system, have various values—in other words, regardless of the base coordinates. Therefore, the representation of electron mass denotes that the modular eigen-frequency of electron, i.e., one physical system, is always constant. In simple terms, elementary mass remains independent of the values of parameters.

This also means that field has the quantum effect (parameters with specific physical properties are not countable given the nature. However, when they are in a set, they are considered as countable individual particles with specific physical attributes).

<Zero Zone theory> identifies the optimal combination of parameters, i.e., physical quantities that emerge from the invariance equations, in order to determine the eigen-frequency of electron. Invariance equations tend to change, depending upon parameters. Thus, there can be multiple types and permutations of parameters, which are related to the eigen-frequency of electron.

<Zero Zone theory> analyzes various experimental results based on the parameters, i.e., the initial conditions of physical quantities, which are the constant values used by natural science today. The theory establishes the invariance equation with the most optimized parameters and determines the value of the eigen-frequency accordingly.

This is the value of rest mass in modern physics. The eigen-frequency tends to change depending upon the measurement conditions including the speed of electron, etc. in the real-world measurement, i.e., the <Stage of reality>. That is, the relativity theory or the law of quantum mechanics determines the eigen-frequency of electron in measurement.

According to the space-time concept of <Zero Zone theory>, time measurement is reliant upon motion-driven physical changes. Thus, time and time measurement are not the same. The reason is that time is conceptually defined based on the conditions in the <Stage of existence> whereas time measurement involves the cognition of human beings in the <Stage of reality>. Accordingly, time defined in the <Stage of existence> is different from the measurement of time where stages of existence—symbol—reality converge.

Any theory is required to elaborate on the fine intervals between time and the measurement or between time and the motion of the matter, for logical explanation. In this sense, abstract definition, cognition of the object of abstract definition and the measurement involving cognition specifically segregate the space-time concept for explanation. However, the new space-time concept is needed since the stages between definition (time) and measurement (time measurement) cannot be split in effect.

This new concept incorporates fusion and harmony. Fusion here is not simple. Fusion means that the logically identical objects of reasoning have different dimensions, yet cannot be segregated. In other words, fusion here is inclusive of harmony. This emerges as Bohr's concept of complementarity in quantum mechanics.

When one physical system of electron remains independent, this means electron has the eigen-frequency. Differently put, parameters, i.e., the components of electron, do have invariant eigen-frequency through the modular combination.

The modular combination refers to the harmonious fusion of components, that is, parameters. The combination of parameters here is invariant based on the constant structure.

We can have the same answer to the questions such as “where do all physical laws and constants originate from?” or “what is the fundamental principle that links all seemingly random numbers in lab test results?” The answer is “they all result from the invariance principle of the same dimension.”

To natural scientists, it has been deemed impossible to have all theories consistent with test results across all areas reviewed and to be able to present values (other results) that are theoretically predictable in any other areas. However, implication here is that this is never impossible.

Actual and specific equations of natural phenomena and interpretation thereof are based on the mathematical axiom or the physical postulates. Thus, they are established in the <Stage of existence>. In other words, how a game is run is determined in the <Stage of existence> whereas the rule of the game is effectively the definition manifested in the <Stage of reality>.

For example, when viewed from wider perspective, the question about the fundamental concept of “what is energy?” is basically addressing “energy”, the common component of “representations” in natural system. However, the initial condition should be arbitrarily defined, as ‘existence’ cannot be argued in the <Stage of existence>. Here, it is necessary to define the definitive proposition out of at least two possibilities that can be chosen in the <Stage of reality>. The two possibilities are irreconcilable due to the nature of choice. In the <Stage of reality>, one out of the two components that contradict in the <Stage of existence> is chosen and set as the judgmental base.

Then why are two contradicting concepts implied in the <Stage of existence>? This goes back to the raison d'etre of mathematics, which is considered as the mother of all studies. Mathematics is basically about the logical structure that eliminates contradiction. Mathematics inherently assumes the principle of contradiction that a proposition is either true or false and the principle of the excluded middle that there is no third element other than truth and the falseness.

In this sense, it is obvious why definition or conditions of propositions are established more than anything else. What should be noted here is that definitions of two contradicting propositions are equivalent and fall into one dimension in the <Stage of existence>. For instance, good and evil, true and false, “0” and “1” are contradicting concepts in the <Stage of reality>. Yet, they are mutually equivalent and dimensionally identical in the <Stage of existence>.

That is, all conflicting elements including truth and falseness are equally and equivalently positioned, i.e., in the same category in the <Stage of existence>. Qualitative and quantitative comparison is possible only when two contradicting elements exist in the same category and same dimension. As quantitative and qualitative comparison requires objects mutually, two conflicting elements should be multi-conflicting conjugates, rather than simple conflicting elements.

The fact that two contrasting qualitative objects are needed in the same dimension and two contrasting quantitative objects are needed in the same dimension means that bipolarized judgment of the multi-conjugate is needed via the comparison of the two contrasting elements in the same dimension, rather than simple dichotomy. This concept can be an important turning point to overcome the limitation of bipolarized translation that results from the simple dichotomy and comparison today.

In <Zero Zone theory>, it is a very important concept that two contradicting and conflicting elements exist equally in the same dimension, especially when people establish the proposition of concept at their discretion. This is the attribute and the content of the proposition that can be easily overlooked, which actually plays an essential role in the <Stage of reality>. That is, comparison can be done as two conflicting elements exist on the same dimension.

In the <Stage of existence>, energy can be both particle and wave, that is, the duality exists on the same dimension. In contrast, in the real-world of measurement, i.e., the <Stage of reality>, only one out of two possibilities should be chosen. Thus, energy can be measured only in one aspect, that is, as particle or as wave. How it is measured determines the selection here. In other words, the attribute of particle is observed if the measurement device suitable for the particle is used and vice versa. This is also the conclusion of quantum mechanics lately. We cannot simultaneously observe the properties of particle and wave during lab tests since the identity is inevitably chosen. In other words, it is the rule of the game that the existence of proposition should be set up and this is why two different properties do not emerge at the same time.

Let's apply the same logic to the rest state of light and the state of light speed. Rest state and the speed of light that define the state of motion in the same dimension have the inseparable properties in the <Stage of existence>. Yet, in the stage of measurement, i.e., the <Stage of reality>, it is concluded that no matter can simultaneously have both the properties of rest state and the speed of light. A matter that is at rest state cannot move at the speed of light. This is in line with the logical judgment that things cannot be true and false at the same time.

The rest mass of photon is defined as “0” in modern physics. However, when the pressure of photon is recognized from hot sunlight and the existence of photon is effectively recognized, the definition of photon's rest mass as “0” becomes undeniably confusing to modern physicists themselves. Likewise, the confusion concerning “0” and “1” as the true attributes of numbers originates from the property of duality. In other words, regardless of how “0” and “1” are defined, they exist on the same dimension. And the significant attribute, utility and the consequence of this proposition are being overlooked by mathematics and physics today.

In the <Stage of existence>, the definition of the proposition implies the foregoing attribute. Thus, when speed of light is set as “1”, the rest state is no other than “0”. The reason is that the logic refuting the simultaneous existence of the speed of light and the rest state is inevitably at work in the <Stage of reality> as truth and falseness cannot exist at the same time. The speed of light and the rest state are irreconcilable properties, yet they exist in the equivalent dimension in the <Stage of existence>. If they are set equivalent to “1” and “0” respectively, the definition of the proposition can be retained and the logical utility of “1” and “0” can be applied to the maximum in the <Stage of reality>.

When the concept of number “1” is symbolized as the numeric value “1”, it becomes the basic scale of all numbers. Here it serves as the “quantity ruler” qualitatively while it indicates the degree of the quantity. And the concept of number “0” is symbolized as the numeric value “0”. In so doing, it qualitatively serves as the “coordinate ruler” that sets the orientation of “quantity ruler” of all numbers. It is set as the qualitative basis to determine the orientation of + and −. Simultaneously, it plays dual roles as it becomes the quantitative unit of quantity ruler “0”.

Numeric values “0” and “1” arising from the property and the concept of numbers “0” and “1” are in the same dimension of the <Stage of existence>. Not knowing such an aspect, scientists today interpret the simple quantitative meanings of numeric values “1” and “0” during the measurement in the <Stage of reality> and this has led to the confusion surrounding rest mass and pressure of photons and also wave and particles. And this happens since people overlook the fact that two conflicting elements are identical in terms of dimension when defining the propositions and establishing the concepts. Confusion arises when setting up the axiom and the postulate in the <Stage of existence> and people interpret the implication and the quantitative meaning of numbers “0” and “1” only as the quantitative calculation units in the world of measurement, i.e., the <Stage of reality>.

In the <Stage of existence>, two conflicting elements of “0” and “1” are equivalent. However, two contrasting elements assume different functions in the world of measurement. That is, “0” and “1” fall into different dimensions qualitatively and they take different calculation values quantitatively. They assume the dimensions of conjugates (speed of light—rest, truth—falseness, quantity ruler—orientation ruler) of “1” and “0” (1=speed of light, truth, quantity ruler, 0=rest, falseness, orientation ruler). As a result, photon has the property of “1” or “0” in the <Stage of existence> and this is why the speed of light is always “1”, i.e., invariant, and the rest mass of photon becomes “0”.

Likewise, the quantity of photon as a particle is number “1” and this also has the meaning of the smallest common divisor, thereby serving as the starting point for the derivation of the subsequent invariance equation. As wave, photon becomes ‘0’, which means that it does not have quantity, i.e., mass. As a result, photon has the simultaneous meanings of “0” and “1”. In terms of quantity, photon has the aspect of conflicting components of “0” (no mass) and “1” (mass). And in terms of quality, photon has another aspect of conflicting components of “0” (rest) and “1” (speed of light).

II. Translation of the Conjugate Nature of “Light”

Strictly speaking, the simple dichotomy of “light” being particle as well as wave is logically self-contradictory as particle and wave are in two conflicting dimensions. From the perspective of natural science, two conflicting elements cannot exist simultaneously in the same dimension. To be more exact, “light” is countable particle and it is also uncountable qualitative wave, which is in the different dimension. Even in conflicting duality, this means that conflicting elements with logically corresponding dimensions should be matched.

Previously when light is said as both particle and wave, it is logically contradictory since wave and particle are established as two conflicting elements in the same dimension. However, when light is explained to be particle from quantitative perspective and wave from qualitative perspective, wave and particle are not in the same dimension. Rather, they are interpreted as having the attribute of conjugate pair and this correctly defines the dual nature of “light” without any logical contradiction.

If “light” is moving at the speed of light while having countable mass, the concept of mass is quantitative and that of light speed is qualitative. And these two concepts are not in the same dimension and they are conflicting with each other. When the conjugate property of light, i.e., quantitative concept of mass and qualitative concept of speed of light, is correctly understood, we can explain why “light” is phenomenally observed as either particle or wave in experiments. The concepts of mass and speed of light are not conflicting elements in the same dimension (different from the simple division of particle and wave) and they themselves are logically in order without any contradiction.

Let's take an example for easier understanding of “translation of the attribute of conjugate pair”. When we say that a man can never be a woman, this can be easily understood even if we do not explain that the same dimension of sexual function is assumed. However, when we say that a man can be a woman, this can hold if we are actually saying that a man is male in terms of gender, yet is female in terms of personality. That is, the dimensions of gender and personality are not the same. Thus, a person can have male gender, yet with female personality.

Let's expand “translation of the attribute of conjugate pair” into the complex concept of space-time. “Light” being particle as well as wave is not a definition with simple dichotomy. Let's remember that it is particle in one dimension and wave in another.

We can understand that particle has spatial attribute and wave has time function. Time function means that certain function is involved with time. Therefore, “light” is not space-time continuum that has both time and space. Rather, “light” has both time function and spatial attribute simultaneously. The same holds true when time function is replaced with time attribute and spatial attribute with spatial function. Now, let's link the translation logic of space-time to arithmetic operators of algebra or logical operators.

The symbol of intersection (∩) a logical operator, is in the same dimension with arithmetic operators such as multiplication (×) and division (÷). And it implies “and (simultaneous)”, representing spatial attribute in physics. In contrast, the symbol of union (∪), a logical operator, is in the same dimension with arithmetic operators such as addition (+) and subtraction (−). And it implies the meaning of ‘or’, representing the attribute of time in physics.

Based on this understanding, when the concept of conjugate pair is applied, “light” has the spatial attribute and the function of logical operators (union (∪), addition or subtraction) or it has the attribute of time and the function of logical operators (intersection (∩), multiplication and division). In simple terms, “light” has the effect of addition or subtraction as particle as per the principle of invariance equation or has the function to simultaneously multiply or divide as wave.

In so doing, it is found that the concept of infinity is no other than conceptual and qualitative symbol, rather than a numeric value for quantitative calculation. Such translation allows the attribute of duality where space-time is affected by the principle of invariant speed of light and force is at work across infinite distance in different dimensions.

The “Translation of the attribute of conjugate pair” can provide an essential clue to resolve the complexity concerning the translation of multi-dimensional duality, which affects all theories from the aspect of semantics or structuralism, as can be easily seen in the discord between relativity theory and quantum mechanics.

III. Definition of Energy and Energy's Smallest Quantum Unit

Energy is a logical concept that implies all physical properties as the minimum commonality. Thus, it is possible to unify all physical quantities in the dimension of energy. In other words, all individual physical quantities are represented based on the respective definition of the potential capacity in the same dimension.

Such a potential capacity is defined as energy in the <Stage of reality>, where measurement takes place. In effect, scientists name the property of number “1” as energy and basic fundamental physical quantities and various derived physical quantities defined in natural science only represent the quantitative differences of energy, reflecting the property of number “1”.

The quantitative difference of energy refers to the qualitative and the quantitative value of physical quantity as the unique frequency that various natural phenomena manifest. This is to say that numeric values, i.e., the quantitative differences of energy bear dual values, i.e., qualitative and quantitative.

In the <Stage of reality>, dynamic representation of nature, which changes incessantly, is measured. And light energy consists of numerous photons and each one of them is called as a photon. Specifically, when viewed from the dynamic and quantitative aspect of “light”, 1 photon is defined as energy's smallest quantum unit and “1”, the numeric value of dimensionless unit, based on the property of light (1 photon=mass of 1 photon=time of 1 photon=speed of 1 photon=distance of 1 photon) and the concept of number “1”.

In the <Stage of reality> where measurement takes place, numeric value of “0” refers to the quantity of numeric value, rather than the concept of “0”, which is rest “0” equivalent to the concept of speed of light “1” in the <Stage of existence>. This means that “0” does not have any mass.

When “speed of photon” is “1”, it means that second(s), the unit of time defined in fundamental physical quantities, is equivalent to mass or distance of 1 photon. The distance of 1 photon refers to the wavelength of 1 photon as the shortest distance, i.e, Compton wavelength of 1 photon. Compton wavelength is the simple reverse number of the eigen-frequency and as for 1 photon, the reverse number has the value of 1 as well. And this is the unique attribute of photon, the smallest quantum unit with the property of number “1”.

In <Zero Zone theory>, the dimension for the qualitative translation of all physical quantities is unified and the quantitative values of each physical quantity is renormalized into dimensionless numbers, based on the qualitative translation and the quantitative values of energy concerning photon's smallest quantum unit.

When Planck constant as the fundamental constant that exists in natural system is defined as the scale to determine the smallest limit of matter, it has the value of number “1” and it has the same dimension with photon quantitatively and qualitatively. If Planck constant is defined in the relation with photon, i.e., energy's smallest quantum unit, it means that they are differently named despite identical meaning. Thus, matter has fundamentally the same dimension with energy.

As the new concept of energy's smallest quantum unit is established, all physical quantities including the fundamental physical quantity are renormalized into the eigen-frequencies. And they are called Zero Zone Code.

The physical implication of Zero Zone Code is that all elementary particles and various natural phenomena that are scientifically observed and measured do have their eigen-frequencies. If such conceptual approach is expanded, we can naturally explain the theorem of fundamental dimension, translation of energy's definition and energy's smallest quantum unit. Therefore, energy's smallest quantum unit that can be measured in reality via physical attribute becomes the actual basic physical quantity of 7 fundamental physical quantities.

In other words, 7 fundamental physical quantities consist of basic physical quantity, which is in one dimension. The implication here is that the compatibility and the equivalence can be established among 7 fundamental physical quantities. And this implies an important message for the genuine paradigm shift.

When second(s), the fundamental physical quantity, is “1”, it becomes the basic physical quantity itself. As for the relations between the fundamental physical quantities and the basic physical quantity, they are dimensionally unified and this allows the conversion of all physical quantities into dimensionless numbers. This can be likened to the fact that the fundamental data unit in computers is byte, yet data itself consists of bits, which are the basic data unit with identical dimension.

IV. Strict Compliance of Energy Conservation Law

From physics perspective, the law of conservation is kept when Planck constant or the number of photons is conserved on the left and the right sides of equation. The left and the right sides of equations mean that the concept of time is at work in the combination of physical quantities for different events. And this means that numeric values of physical quantities based on photons, i.e., energy's smallest quantum, are conserved on the right and the left sides of equal (=, substitution operator).

And from mathematics perspective, logical values of operands including arithmetic operators, etc. are effectively established without any contradiction. From computer language perspective, computer calculation based on logical operators, etc. can be executed within a certain time without errors or bugs. Energy is conserved in the world of measurement and this means that proposition logic is conserved. In this sense, the conceptual definition of energy transcends the simple physical concept and is expanded into the universality or invariance, which is conserved intact in the world of measurement.

V. Scale Invariance

In the invariance equation of structured module of a certain physical quantity as per <Zero Zone theory>, the unit modules forming

$$\frac{ C m}{V} = {10}^{- 7}$$

(the derivation process is subsequently explained), i.e., parameters such as [symbol] (coulomb constant), C (charge quantity, Coulomb), V (electric potential, volt) and m (distance, meter) have invariance numbers along with a certain invariance equation, regardless of the arbitrarily defined numeric values. This is called scale invariance.

Even if values of parameters, i.e., unit modules, are constant, <Zero Zone theory> determines the numeric values of each parameter based on interpretation, numeric values of 4 physical quantities (speed of light C, permittivity εₒ, permeability μₒ and gravitational acceleration g) that human beings have defined and values that have been obtained from numerous lab tests.

In so doing, it is found that we can calculate ultra-precise values while retaining consistency with various experimental phenomena that high-tech research institutes across the world (Fermi National Accelerator Laboratory of U.S., CERN (Counseil Europeen Pour La Recherche Nucleaire of Europe), KEK (High Energy Accelerator Research Organization of Japan), etc.) have announced.

Goedel's incompleteness theorem about mathematical proof previously proved that numeric values of each parameter in unit module could not be derived via pure mathematical arguments. Thus, their values can be freely determined and they can theoretically have infinite values due to infinite permutations and combinations.

We need to pay attention to the fact that invariance numbers can have various values due to infinite calculation methods that satisfy the invariance equations. Generally speaking, answers to the given questions are important. However, it is widely accepted that how questions are asked is more important in all areas of science.

Yet, scientists can hardly present why due to lacking consideration of mathematical logic. The answer here has much to do with the concepts of choice and freedom with respect to invariance equations and invariance numbers. This is why how we combine which parameters to reach the answer (result) is much more important and useful, compared with the answer (result) itself. The reason is that basic parameters can be combined in different manners, producing parameters with totally different physical properties.

For example, if numbers are the means of communications for all areas of science, astrophysicists would want to find out parameters concerning astrophysical equations or laws and they would not be so much interested in parameters related to biology or civil engineering.

Nature selects minimum number of highly restricted parameters, i.e., constraints, producing harmony of everything. Nature imposes the concept of equality on everything via the so-called invariance equation while deploying the concept of freedom, which allows infinite possibilities in nature itself. The duality of concepts of freedom and equality is closely linked to the concept of number “1” and this becomes the basic principle to establish energy's smallest quantum unit.

In effect, 4 physical quantities (3 depending on the interpretation), i.e., parameters forming invariance equations, become the fundamental elements of natural phenomena. These fundamental elements correspond to 4 arithmetic operators (3 logical operators in some cases) at the core of computer programs. More specifically, these operators lead to standard syntax, i.e., the common architecture of all language syntaxes.

At the center of scale invariance, individual numeric values of parameters do not matter. Rather, the nature's principle as a result of structural combination is represented as invariance equation and it maintains a certain numeric value along with a certain formula (algorithm).

Science is not only about theories, but about proof via tests. In <Zero Zone theory>, it is notable that individual numeric values of physical quantities are not mathematically proven, but validated through test results. In other words, test results of simple individual physical quantities and the concerned mechanism are not sufficient at all. Rather, the relationship and the structural implication among them (e.g. invariance equation) are more useful in effect. This is why equations and numeric values of individual physical quantities from such a structural perspective practically matter.

Two major utilities of relationship among physical quantities, i.e., the concept of invariance number extracted from invariance equations, are ease of calculation and relations of various physical properties.

⊚ Converting SI Units (Basic Units and Derived Units) into Absolute Numeric Values

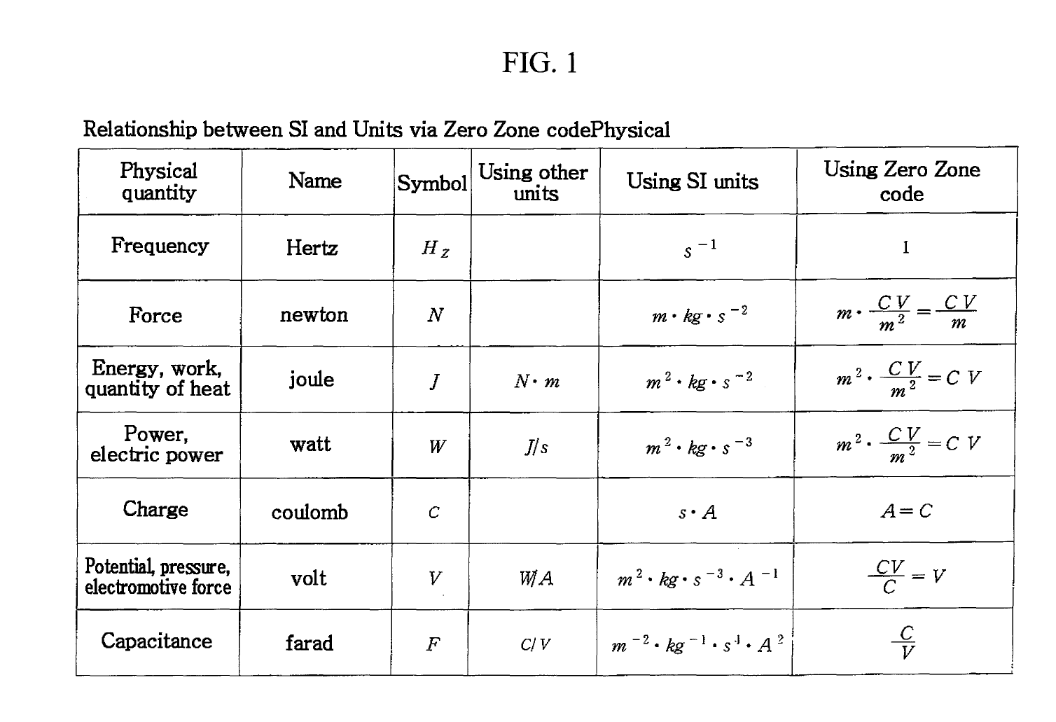

When diverse and complex units used in physics today are subject to the theorem of fundamental dimension (c=h=1) as per <Zero Zone theory>, we can come up with a very simple standard compilation code (Zero Zone code) in FIG. 1.

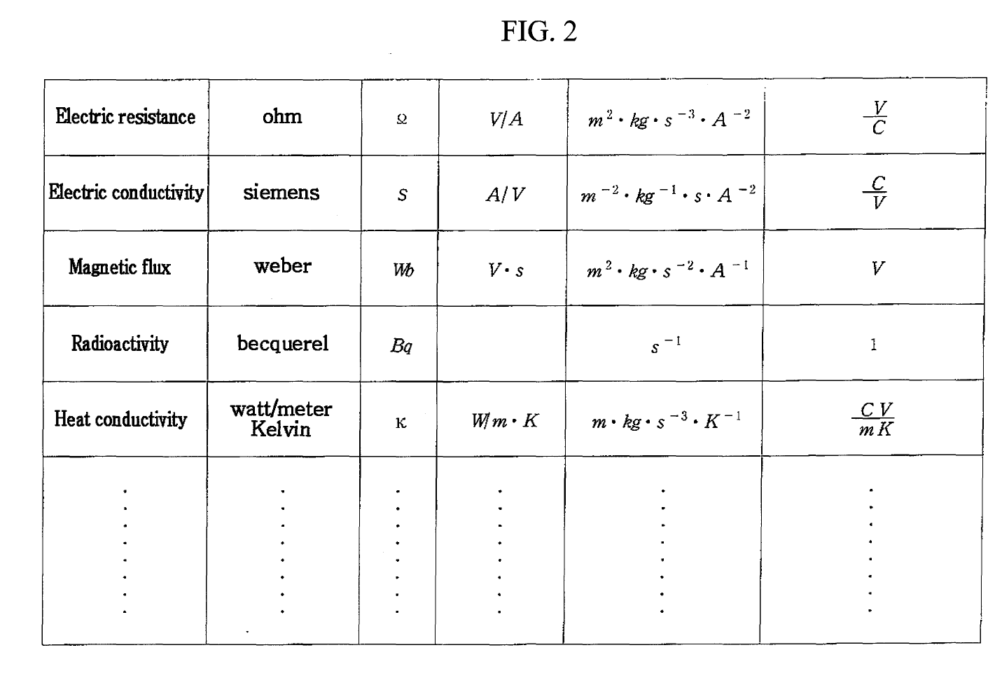

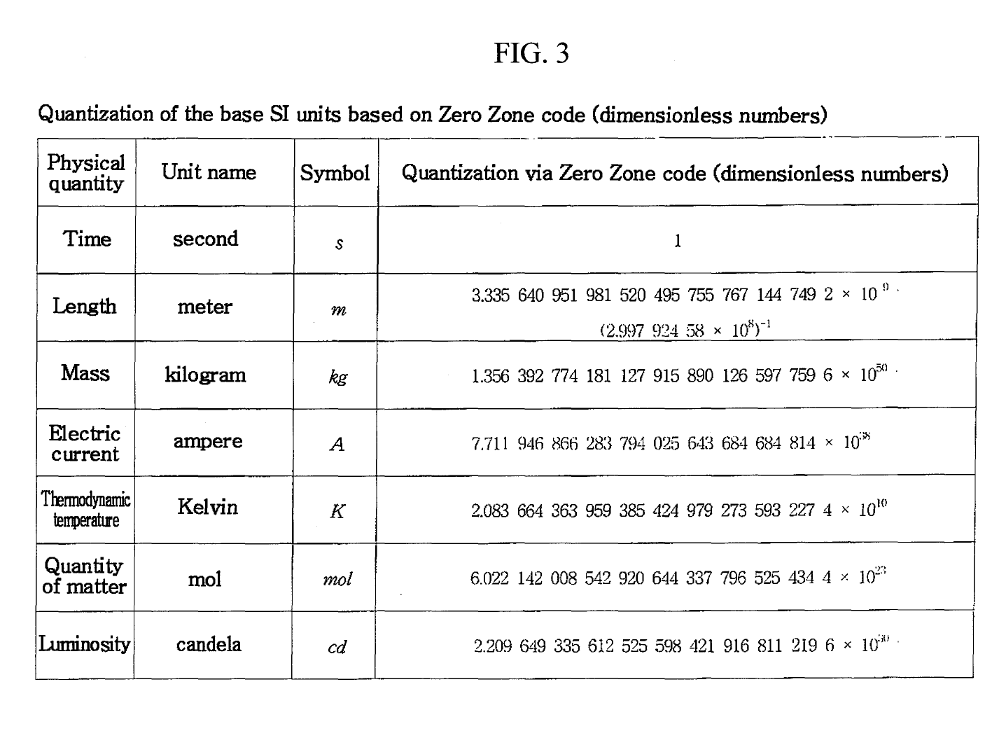

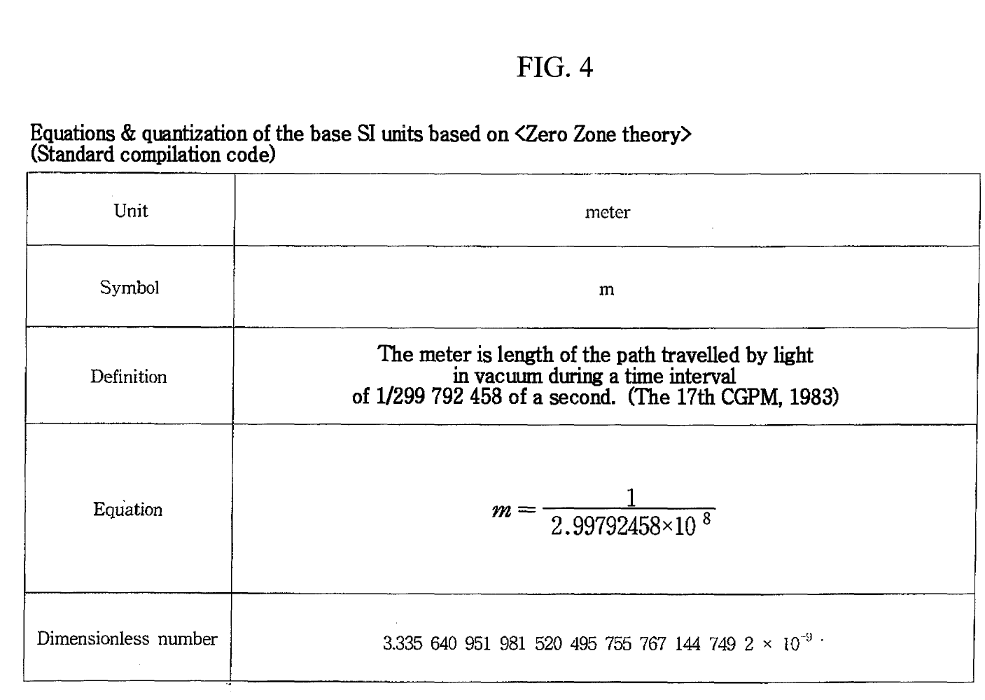

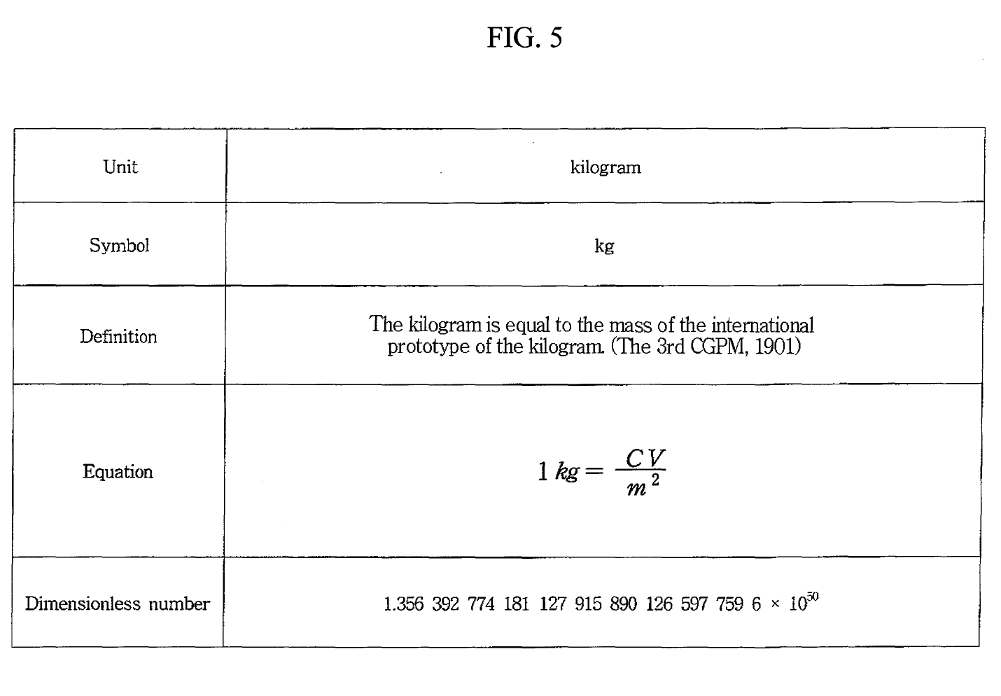

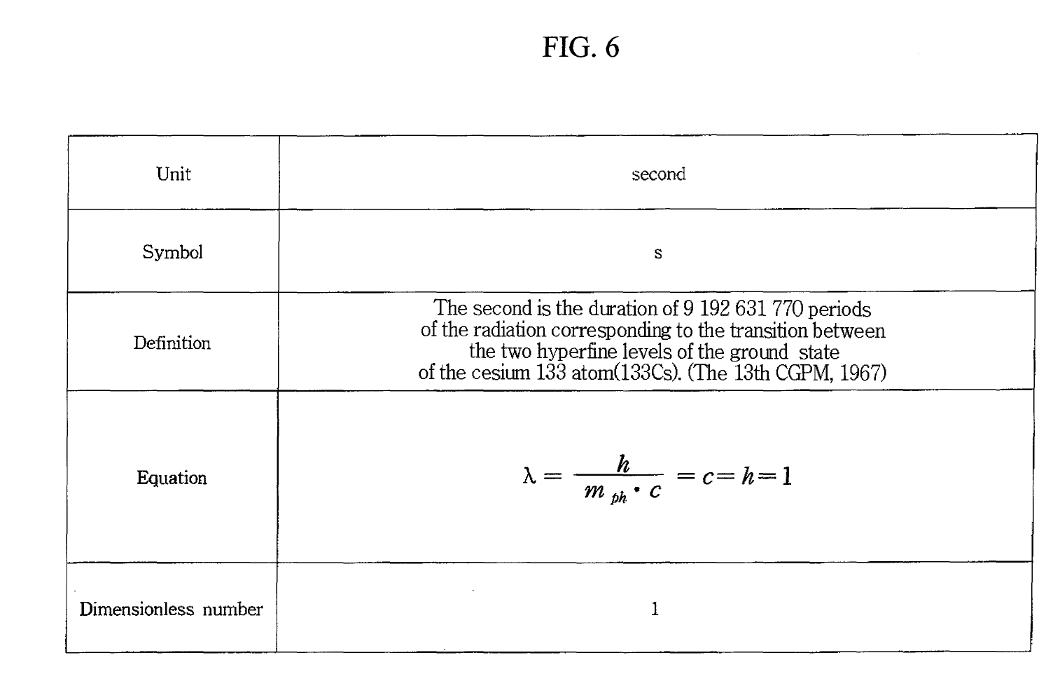

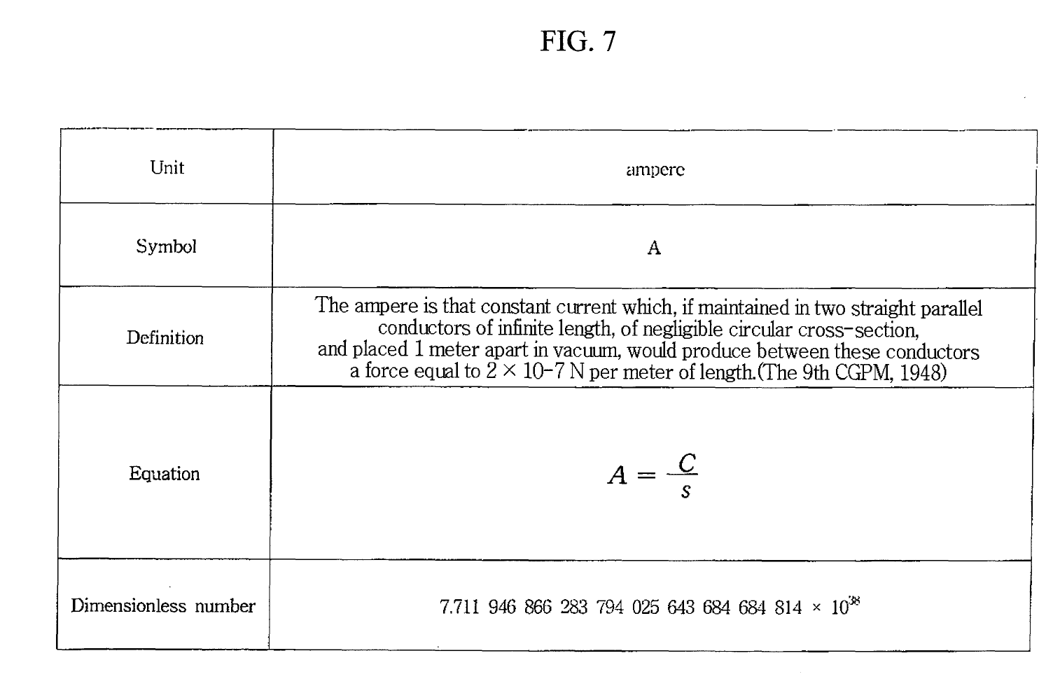

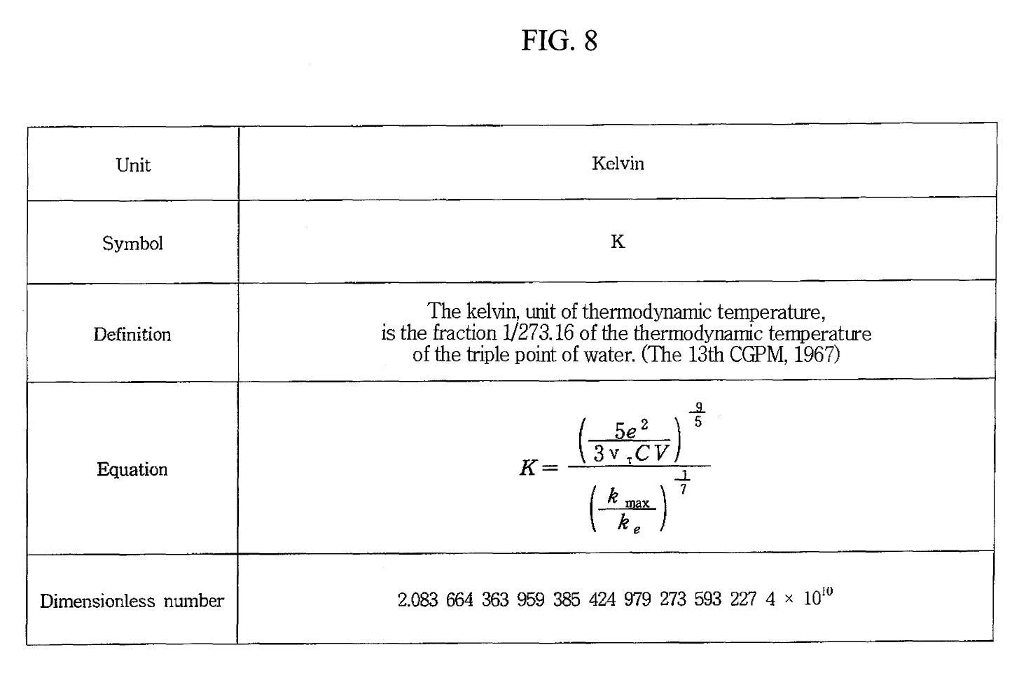

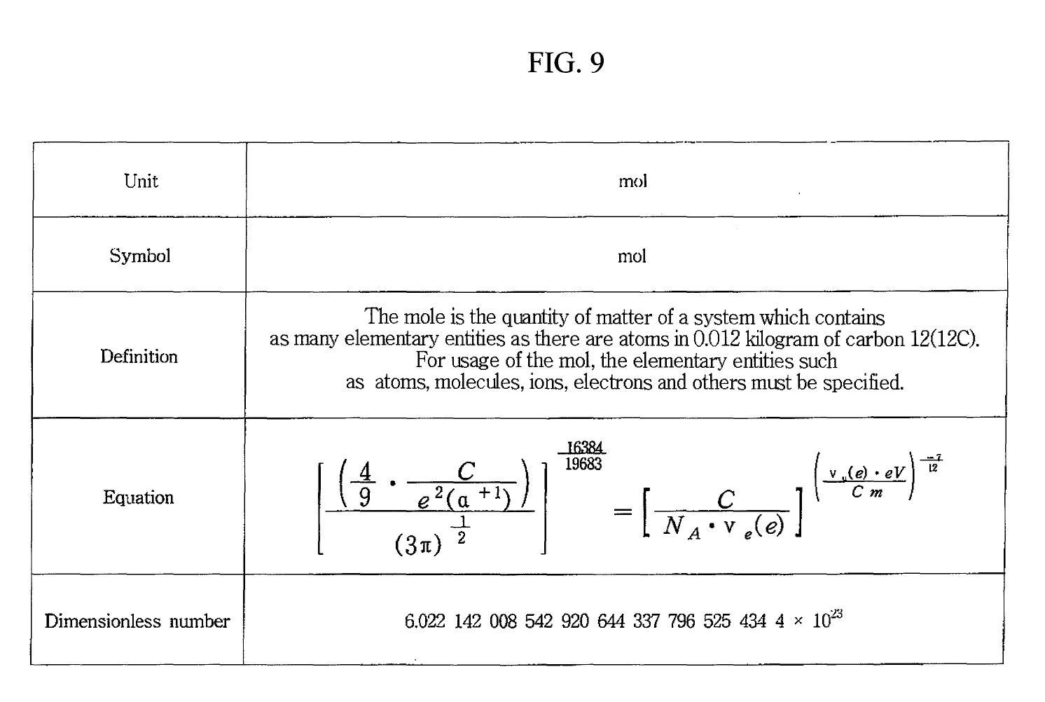

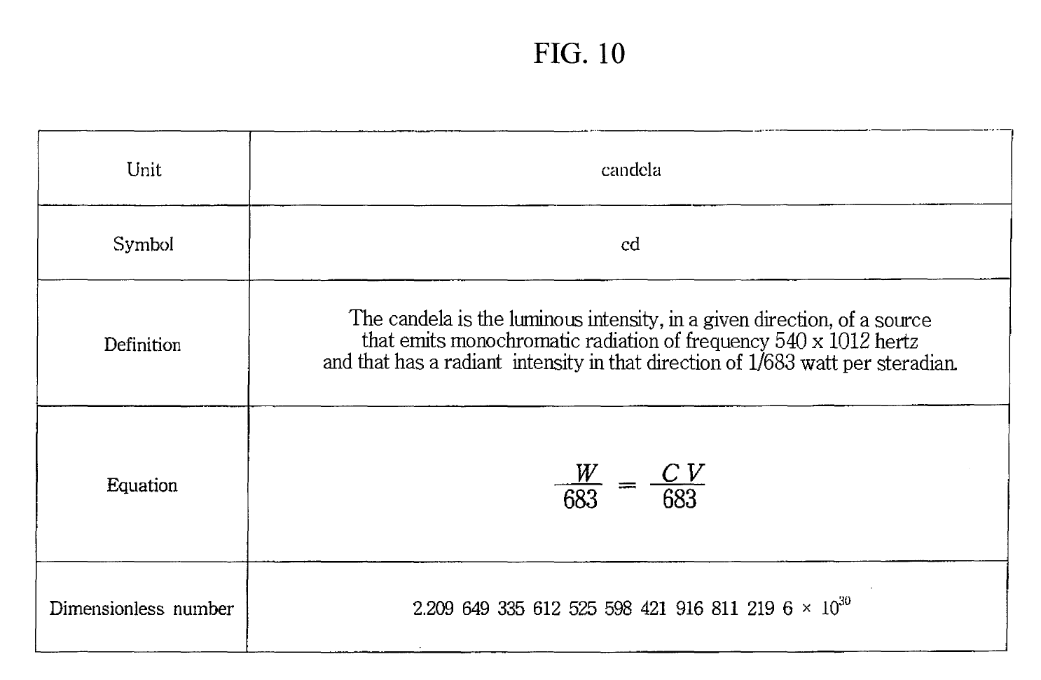

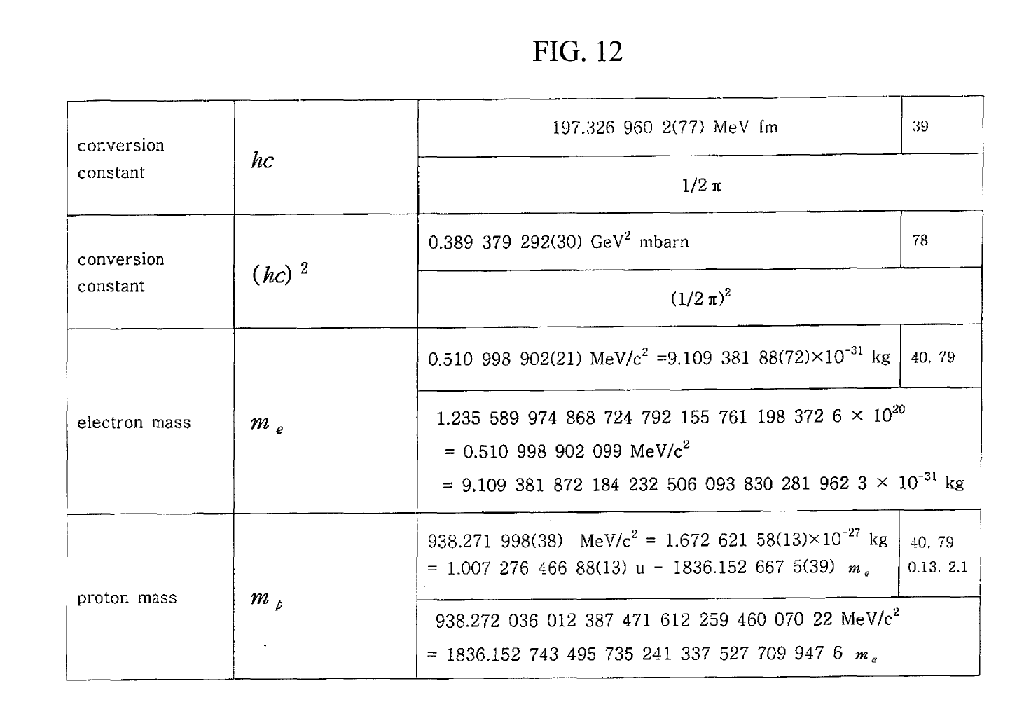

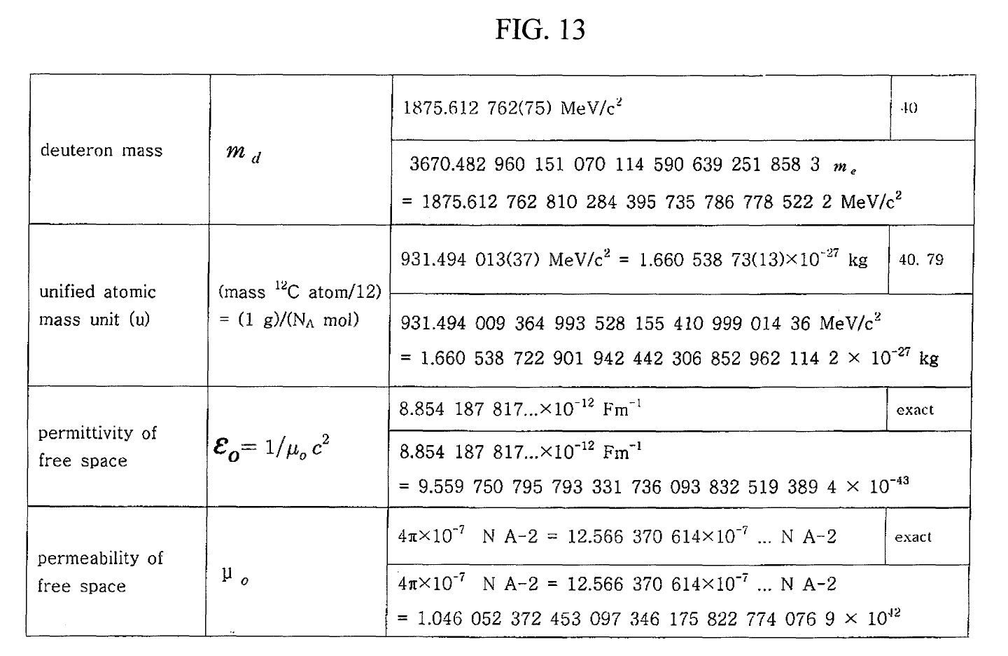

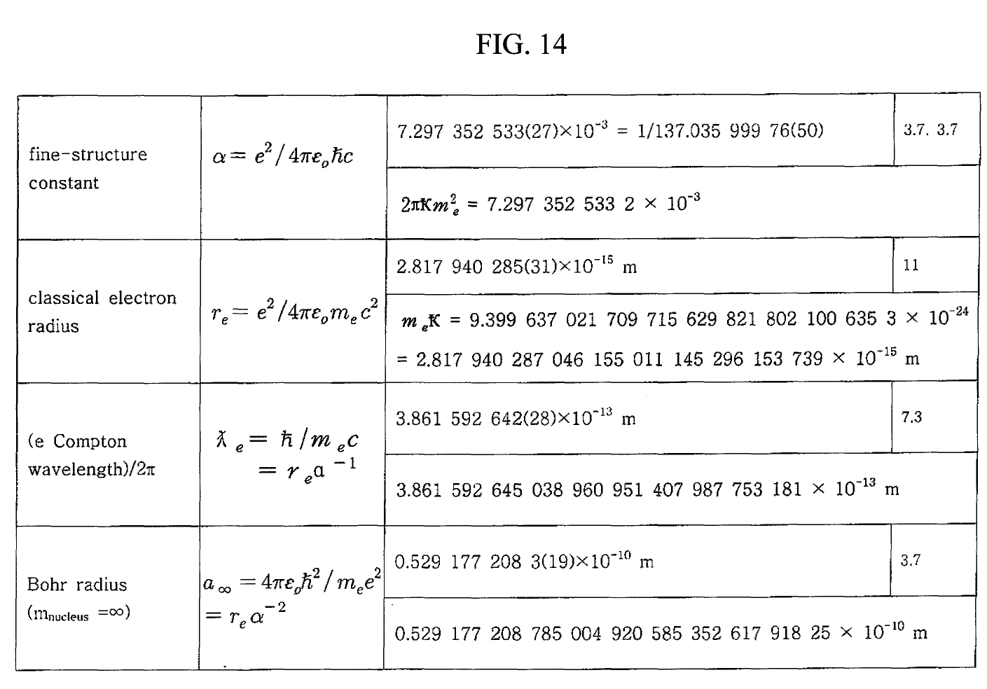

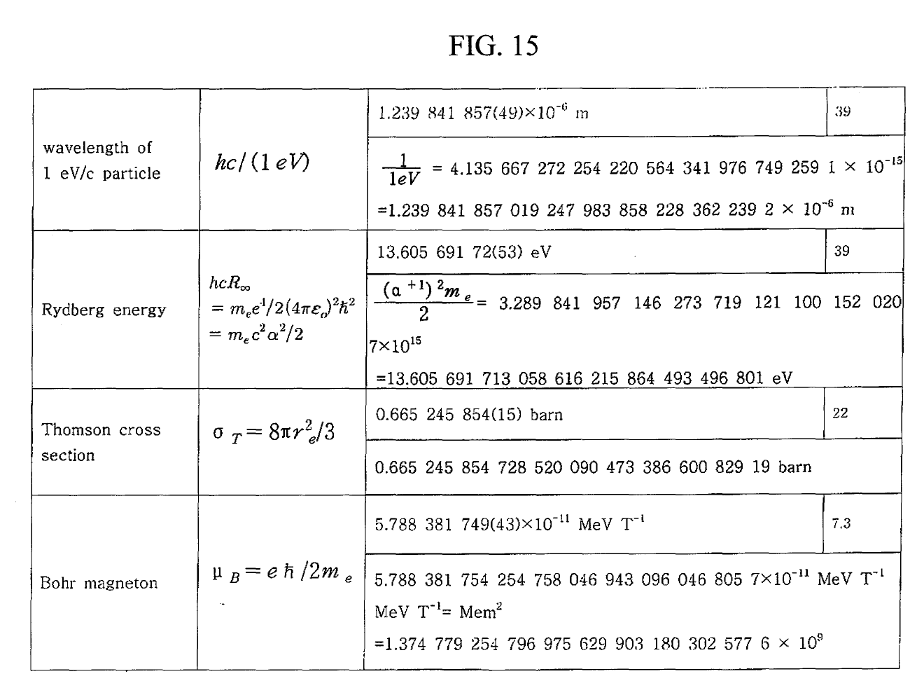

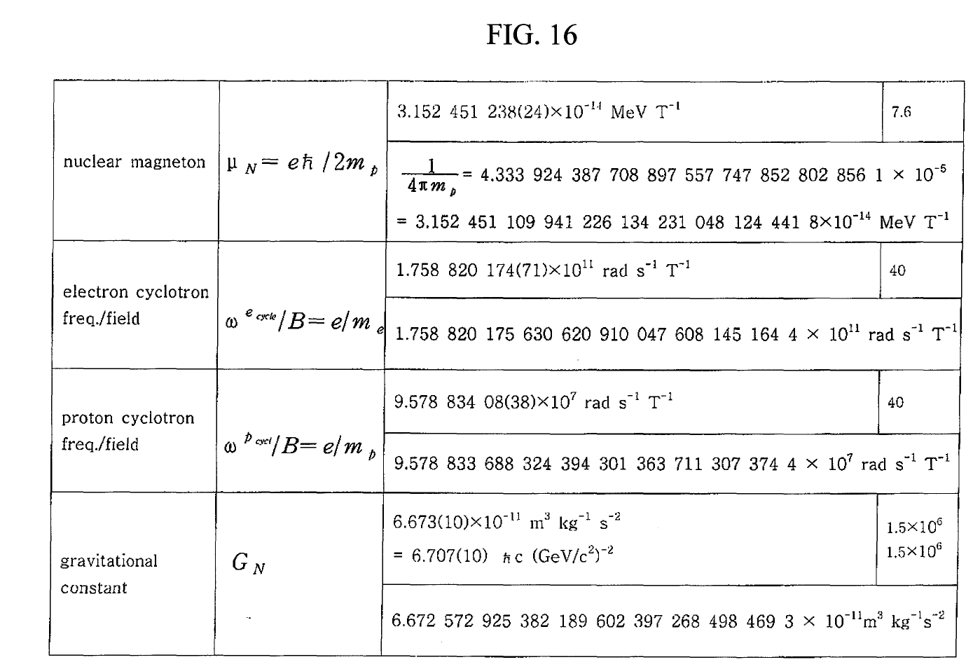

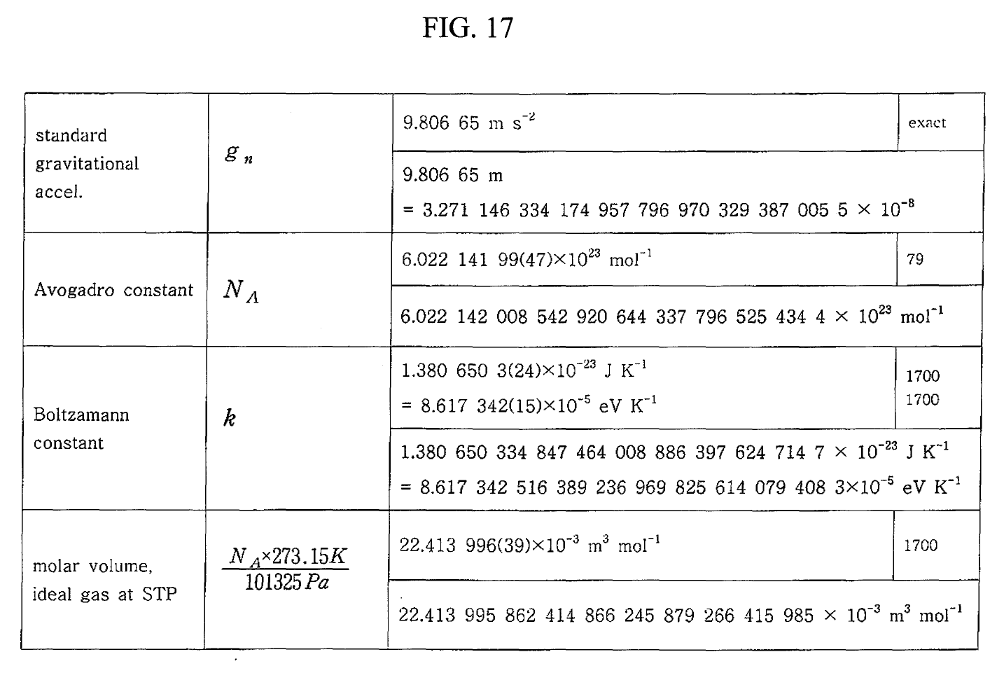

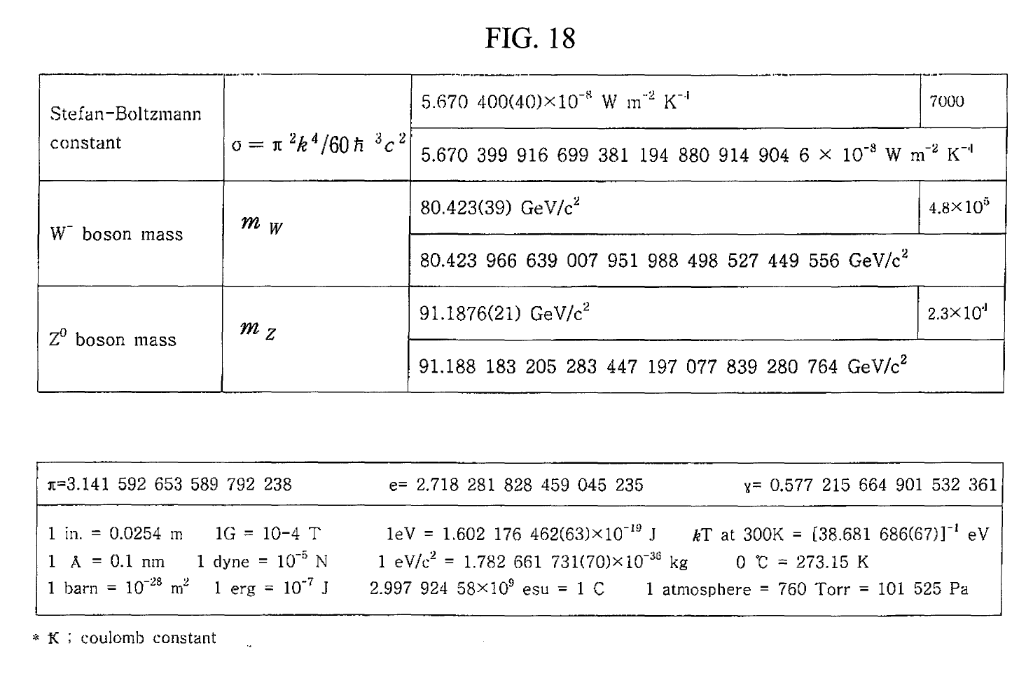

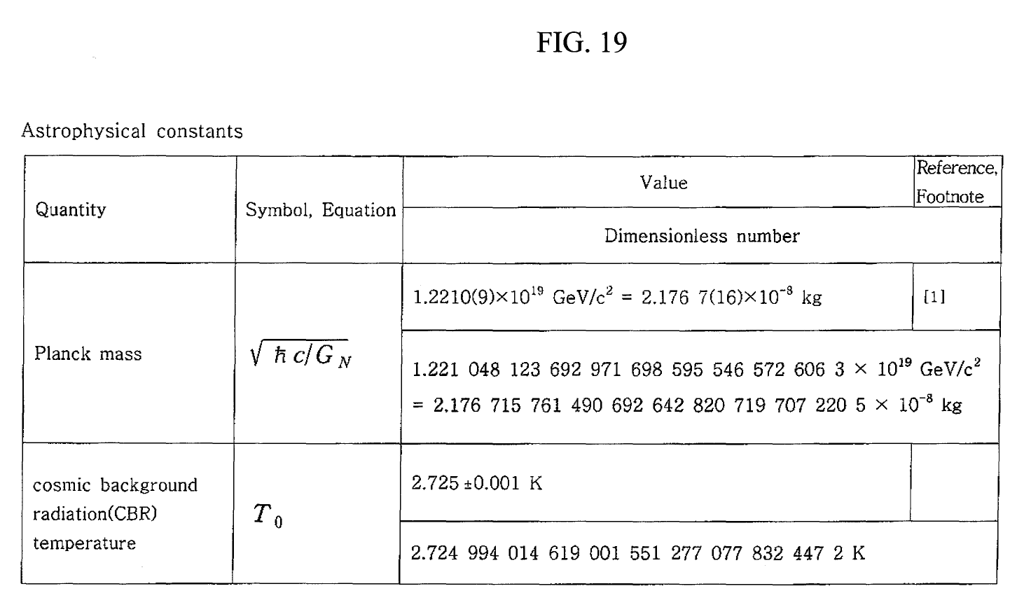

For the conversion into numeric values, diverse and complex physical quantities (units) are converted to the unified unit as per Zero Zone code and they can be simply calculated based on the quantized values (dimensionless numbers) of physical quantities in FIGS. 2 to 19, which are derived from <Zero Zone theory>.

In broad sense, the quantized values of physical quantities explained in FIGS. 2 to 19 are Standard compilation code (Zero Zone code) as well. That is, the codes to convert physical quantities of different semantic dimensions into dimensionless numbers via quantization also fall into the category of standard compilation code (Zero Zone code).

The theorem of fundamental dimension as per <Zero Zone theory> essentially simplifies physical quantities (units) today that are represented with diverse and complex names and symbols into several units. Furthermore, this allows calculation of physical quantities (units) with different meanings that could not have been calculated due to different dimensions, by means of dimensional unification. As a result, all users ranging from scientists, engineers to laymen can enhance their understanding of terminology of natural science, which have been deemed hitherto complex and difficult. Ultimately, this is aimed to provide an innovative mechanism (interface) to make all essential calculations and measurements easy and convenient in researches, industries or daily lives.

⊚ Implication, Derivation Process and Validation of New Invariance Equation of <Zero Zone Theory>

Among various physical constants used in natural science, the 4 following physical quantities are previously defined without any uncertainty, unlike any other physical quantities.

| | Symbol, | | Uncertainty |
|---|---|---|---|
| Quantity | equation | Value | (ppb) |
| Speed of light | c | 2.99792458 × 10⁸ ms⁻¹ | Exact |
| in vacuum | | | |
| Permittivity of | ε₀ = | 8.854187817 . . . × 10⁻¹² Fm⁻¹ | Exact |
| free space | 1/μ₀c² | | |
| Permeability of | μ₀ | 4π × 10⁻⁷ NA⁻² | Exact |
| free space | | | |
| Standard | gₙ | 9.80665 ms⁻² | Exact |
| gravitational | | | |
| accel. | | | |

Equation of the First-Invariance

The first invariance equation is derived from the theorem of fundamental dimension and 4 previously defined physical quantities. As c=h=1 (s=1) in the theorem of fundamental dimension, the relationship of reverse numbers is established between permittivity and permeability from the equation of permittivity, εₒ=1/μₒc²=1/μₒ as follows;

εₒ·μₒ=1

And as for the relationship between permittivity and permeability, when dimensions are simplified, μₒ=4π [symbol] ( [symbol] is coulomb constant,

$$F = \frac{1}{4 π {ɛ}_{o}} \cdot \frac{{q}_{1} \cdot {q}_{2}}{{r}^{2}} ) ,$$

whence

$${μ}_{o} = 4 π = \frac{4 π \times {10}^{- 7} N}{{A}^{2}} \qquad 1 ◯$$

In the foregoing equation, μₒ still has the dimension of a derived unit.

When time(s), the fundamental physical quantity, is quantized and set as dimensionless number “1” and equation \textcircled{1} is converted to Zero Zone code as per the theorem of fundamental dimension for dimensional reduction, we get

$$\begin{matrix}{μ}_{o} = 4 π = \frac{4 π \times {10}^{- 7} N}{{A}^{2}} \\ = 4 π \times {10}^{- 7} \times \frac{C V}{m {C}^{2}} \\ = 4 π \times {10}^{- 7} \frac{V}{C m}\end{matrix} \\ ∴ = \frac{{10}^{- 7} V}{C m} \qquad 2 ◯$$

If equation \textcircled{2} is simplified,

$$\frac{ C m}{V} = {10}^{- 7} \qquad 3 ◯$$

And the physical quantities used in equation \textcircled{3} are as follows;

[symbol] (Coulomb constant), C (Charge quantity, coulomb), V (electric potential, volt), and m (distance, meter).

Equation \textcircled{3} is the first invariance equation and 10⁻⁷ as the invariance number is the constant that satisfies the first invariance equation and it is represented as I₀₋₁.

Equation \textcircled{3} is translated as follows in relation to the scale invariance.

No matter what values [symbol] , C, V, m (parameters) may take, which are unit modules forming

$$\frac{ C m}{V} = {10}^{- 7} ,$$

a structured module of a specific physical quantity, the invariance equation of \textcircled{3} and relationship satisfying the invariance number (10⁻⁷) are established. This is scale invariance that produces the core algorithm of Standard compilation code. The values derived from the combination of parameters, i.e., unit modules, are invariance numbers and they are constant regardless of transformation.

Specifically, the implication of invariance equation and invariance numbers in the stage of measurement is as follows; Given that parameters in the foregoing equations are values without dimension, physical quantities of [symbol] , C, V, m do have the constant value of 10⁻⁷ regardless of how they are arbitrarily set—regardless of attributes of time and space (in other words, no matter how space-time is defined or despite the passage of time or change of spatial structure).

Therefore, the structural combination of parameters representing nature's physical properties implies the attribute of number “1”, the energy's smallest quantum unit while retaining the relation of structural combination of 10⁻⁷.

Let's take a look at why language letters (strictly defined logical representation such as physical quantities or computer commands) should be converted into values. What can be inferred here is that we can express parameters representing the physical properties of nature into simplified numeric values, based on the structural combination relations among invariance equations and invariance numbers, which reflect the invariance of nature.

That is,

$$qualitative = quantitative .$$

This means that numeric values tend to contain both the qualitative meaning and the quantitative information if physical properties of nature are represented via numeric values that satisfy invariance equations and invariance numbers. In this case, the value has the duality of two conflicting properties in the same dimension. Duality reflects the property of number “1”.

Therefore, number “1”, energy's smallest quantum unit, actually has the relation of the set theory in

$$qualitative - same dimension - quantitative$$

and the attribute here is no other than “Oneness”.

The relation of the set theory can be further explained based on stages of space-time defined in the theorem of fundamental dimension and numbers and 3 major physical constants (Newton constant, Einstein constant and Planck constant) that human beings have identified as follows;

‘Qualitative’ is a real number, representing the concept of energy itself. This refers to Einstein constant with the principle of the invariant speed of light, that is, in the <Stage of existence>.

‘Quantitative’ is another real number. It has the same quantity with ‘qualitative’, yet with different direction. This constitutes the concept of mass and represents Planck constant with quantum principle, that is, in the <Stage of reality>.

‘Same dimension’ is the union of two imaginary numbers with the same quantity, yet different directions. And this provides the continuity, i.e., the link between ‘qualitative’ and ‘quantitative’.

Newton constant containing the concepts of space-time and gravity that determines the transformation ratio between energy and mass represents the <Stage of reality>. Especially, in this stage, the concept of gravity is highlighted and here exists the imaginary number that analogously links two separate substances (real numbers). The Newton constant means that the two foregoing real numbers can never be segregated.

In the <Stage of existence>, this imaginary number has the inseparable attribute along with energy and mass. When it comes to the world of measurement, i.e., the <Stage of reality> where energy and mass are separated, it is replaced with the real number, which has the effect. (Quantization of imaginary number)

Accordingly, we can write a simple equation as follows;

c=h=G=1(Stage of existence)

c·G=+i,h·G=−i(Stage of symbol)

c=h=1≠G(Stage of reality)

This fundamentally accounts for why Newton's 3 laws of motion are derived. Besides, this offers the foundation for the interpretation of properties and dimension of fundamental physical quantities such as force, mass, acceleration, etc. and derived physical quantities.

The set relationship among 3 major physical constants is quantitatively represented via the symbol (metaphor) of number 3, which has the meaning of number 3. In other words, when one equals three, it sounds quite simple. Yet, it implies the complex logical concept of invariance, which emerges in the form of homeostasis.

Regarding the question of why nature retains homeostasis, we can explain that the principle of invariance, i.e., oneness is harmoniously incorporated in everything.

Therefore, in terms of energy conservation, the true attributes of energy already contain invariance principle and the logical structure is preserved in the world of measurement. Invariance principle implies the meaning of numbers and concept of quantization.

Not understanding the foregoing invariance principle, human beings have arbitrarily assigned names and symbols to individual physical properties of nature, drawing up and translating equations.

For instance, we have observed, measured and analyzed how diverse physical properties of nature interact and identified the relationships among them, deriving and utilizing various equations.

Now, if we use invariance principle, we can simplify any representations of complex units as has been exemplified above. (Refer to the relationship between SI and Zero Zone code in FIG. 1)

Let's take a look at a specific example of applying equation \textcircled{3} to industrial engineering with respect to scale invariance.

When invariance principle is applied to computer engineering, it is possible to come up with the mechanism for a logical structure where letters/symbols, i.e., the basic unit of computer data input and numbers are compatible.

As the compatible logical structure is extracted based on invariance equation and invariance numbers, the dimensional barrier of current fundamental units and derived units can be overcome and new computer operation mechanism can be created. Any equations can be easily translated in terms of the meaning and the qualitative content. Recognizing such possibility, the Nobel laureate <Feynman> expressed his frustration for not being able to do so.

Basic dimensionless numbers implying specific meaning are utilized for the overall process of measurement, analysis and operation, etc. of all physical quantities in the fields of natural science and the operating system here is beyond the simple OS of computers. This is the newly expanded OS in the computer system itself, which is the higher-level concept of computer languages, rather than a specific OS of computer language.

At the same time, this OS is made of an innovative method of numbers themselves=equations=algorithms=computer programming language=computer program. This will trigger technological innovation in computer science and engineering.

Equation of the Second-Invariance

The 2^{m1} invariance equation is derived from the theorem of fundamental dimension and the 1^{st} invariance equation, which is inferred from the 4 previously defined physical quantities.

First of all, fine-structure constant is expressed in the following equation.

$${α}^{+ 1} = \frac{{e}^{2}}{4 {πɛ}_{o} ℏ c} \qquad 1 ◯$$

When equation \textcircled{1} is simplified based on the theorem of fundamental dimension and (c=h=1) and εₒ·μₒ=1, μₒ=4π [symbol] ,

$$ℏ = \frac{h}{2 π} = \frac{1}{2 π} , \\ {α}^{+ 1} = \frac{{e}^{2}}{4 π {ɛ}_{o} ℏ c} = \frac{{e}^{2} {μ}_{o} 2 π}{4 π} = \frac{{e}^{2} 4 π 2 π}{4 π} = 2 π {e}^{2} \\ \frac{ C m}{V} = {10}^{- 7} and , m = \frac{1}{c} , \qquad 2 ◯$$

when equation \textcircled{2} is simplified,

$$\frac{C}{V} = F = 2.99792458 \times {10}^{8} \times {10}^{- 7} = 29.9792458$$

$$F = \frac{C}{V} ( Capacity \text{:} farad )$$

Currently, equations \textcircled{1} and \textcircled{2} are used to fix the value of parameters determining fine-structure constant, which is the only physical constant that is represented as a dimensionless numbers. In addition, based on the analysis of experimental phenomena, values of Planck constant and electron mass, ratio of electron—charge, etc. that are relatively precisely determined compared with other constants are referred to as well.

Values extracted from the combination of parameters should be consistent with experimentally identified fine-structure constant, which is highly precise.

When all these elements are considered, the new invariance equation is derived as follows;

$$\frac{{e}^{2 ( x - 1 )}}{{C}^{( x - 1 )}} = \frac{{V}^{( x + 1 )}}{{m}^{x}}$$

That is, the equation of e^{2(x-1)}·m^{x}=C^{(x-1)}·V^{(x+1)}=constant—\textcircled{3} is separately called as the 2^{nd} invariance equation.

The physical quantity and its implication of parameters forming the equation are as follows;

e (electron mass, eigen-frequency of electron), C (charge quantity, coulomb), V (electric potential, volt), m (length, meter), x (Invariance number; this is the invariance number that satisfies the 2^{nd} invariance equation and marked as I₀₋₂)

Equation of the Third-Invariance

The 3^{rd} invariance equation is derived from the 1^{st} and the 2^{nd} invariance equations that are inferred from the theorem of fundamental dimension and the previously defined 4 physical quantities.

In particular, the 3^{rd} invariance equation can be called as the equation of electron. You will see that the equation itself is the simple combination of physical quantities from the 1^{st} and the 2^{nd} invariance equations.

$${e}^{2} = \frac{m}{2 π \times {10}^{- 7}} \times \frac{C}{V} \times {α}^{+ 1} \qquad 1 ◯$$

As

$${α}^{+ 1} = \frac{{e}^{2}}{4 {πɛ}_{o} ℏ c} = \frac{{e}^{2} {μ}_{o} 2 π}{4 π} = \frac{{e}^{2} 4 π 2 π}{4 π} = 2 π {e}^{2}$$

in the 2^{nd} invariance equation,

we can write the equation \textcircled{1} as:

$${e}^{2} = \frac{m}{2 π \times {10}^{- 7}} \times \frac{C}{V} \times {α}^{+ 1} = \frac{m}{2 π \times {10}^{- 7}} \times \frac{C}{V} \times 2 π {e}^{2} \qquad 2 ◯$$

and equation \textcircled{2} can be written as:

$$1 = \frac{m}{{10}^{- 7}} \times \frac{C}{V} \times$$

The foregoing equation is consistent with

$$\frac{ C m}{V} = {10}^{- 7} ,$$

which is derived from the 1^{st} invariance equation.

The following is the description of the equation of electron in the theorem of fundamental dimension.

As per <Zero Zone theory>, the invariance principle means that physical laws represented via invariance equations are independent of definition and base coordinate system. Let's take the former for an example. It is found that the eigen-frequency of electron (dimensionless number) consists of the combination of certain parameters and this is one of invariance equations. The value of each parameter forming the invariance equations is not fixed, yet determined from the initial conditions.

Actually, electron mass (rest mass) is experimentally determined based on the arbitrarily determined value of parameter (physical quantity). In other words, any change of initial conditions will impact the value of parameters. However, this does not influence invariance equations and the eigen-frequencies.

This is to say that electron mass is constant no matter what values parameter can take, which forms electron, i.e., a physical system—differently put, no matter which coordinate system is selected. Therefore, electron mass actually means that the modular eigen-frequency of one physical system of electron is constant. In simple terms, electron mass is independent of parameters.

And this means that field has the quantization effect (parameters with the specific physical attributes are not countable, given the nature. However, when they form a set, they are considered as individual particles with specific physical properties).

In <Zero Zone theory>, the process of determining the eigen-frequency of electron starts from the identification of the optimal combination of parameters, i.e., physical quantities in invariance equations.

The invariance equation is not necessarily one and only. It changes depending upon parameters. And there can be multiple types and combination of parameters that are related to the eigen-frequency of electron.

In <Zero Zone theory>, various experimental results are analyzed based on parameters, i.e., constants that are determined and used in natural science, which are the initial conditions of physical quantities. And invariance equations of the most optimized parameters are identified and they are used to determine the numeric values of the eigen-frequency.

This is the value equivalent to rest mass in modern physics. And in the real measurement environment, i.e., the <stage of reality>, measurement conditions including the speed of electron, etc. determine the eigen-frequency. That is, relativity theory or quantum mechanics law determines the eigen-frequency of electron when measurement is done.

Lab test results that are measured currently are actually logical values that inevitably emerge based on the 1^{st} and the 2^{nd} invariance equations.

Despite measurement via repeated experiments over time, the significant figures up till now are only 3 or 4 digits since test results only are referred to without proper consideration of the arbitrarily input values at the beginning of tests. The reason is that the relationships among parameters and the mechanism to determine the values of parameters are not exactly understood.

<Zero Zone theory> derives the equation of electron, i.e., the 3^{rd} invariance equation to determine the eigen-frequency of electron based on the 1^{st} and the 2^{nd} invariance equations. Each parameter related to the equation of electron or invariance equations is compared and analyzed against experimental values. In so doing, it is possible to determine exact or more precise quantized values (i.e., dimensionless number without any unit), which are consistent with significant figures, the results of actual tests.

We can easily and quickly validate the exactness or preciseness of these quantized values, by comparing them with experimentally identified major physical constants. However, these values are quantized via renormalization under the condition of c=h=1.

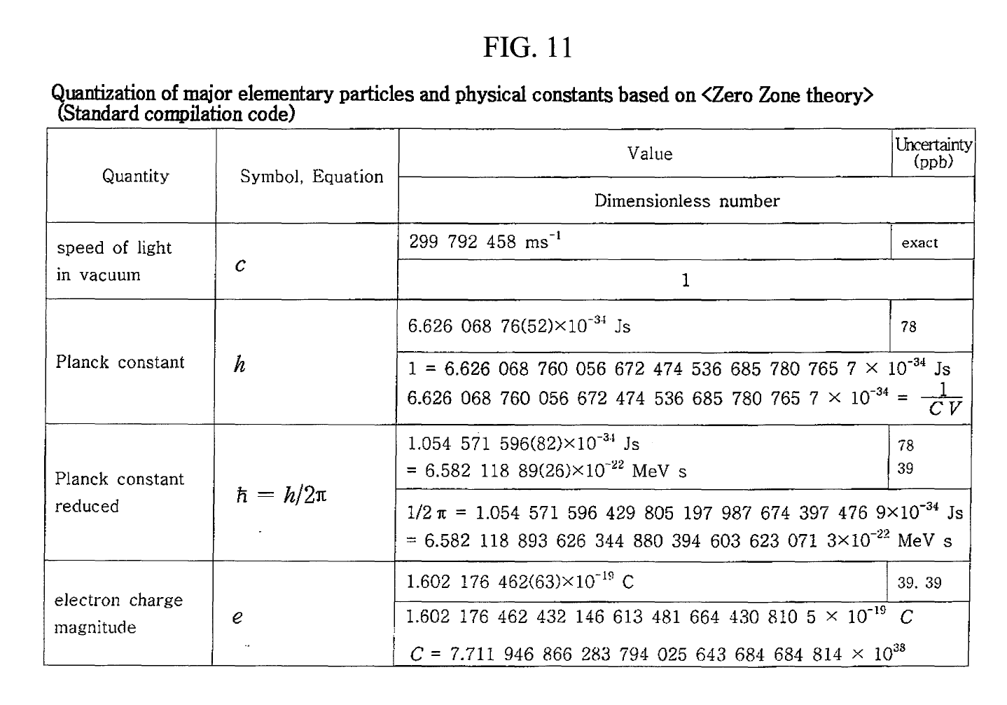

Major examples of Standard compilation code, the quantized values from the 1^{st}, the 2^{nd} and the 3^{rd} invariance equations are as follows; (Refer to Physical constants of FIGS. 11 to 19 for further details)

$$e ( electron mass , the eigen \text{-} frequency of electron ) = 1.235 \; 589 \; 974 \; 868 \; 724 \; 792 \; 155 \; 761 \; 198 \; 372 \; 6 \times {10}^{20} = 0.510 \; 998 \; 902 \; 099 ( MeV . )$$

$$C ( Charge quantity , coulomb ) = 7.711 \; 946 \; 866 \; 283 \; 794 \; 025 \; 643 \; 684 \; 684 \; 814 \times {10}^{38}$$

$$V ( Electric potential , volt ) = 1.956 \; 951 \; 367 \; 003 \; 645 \; 371 \; 172 \; 713 \; 612 \; 315 \; 9 \times {10}^{- 6} = {( 5.109 \; 989 \; 020 \; 99 \times {10}^{6} )}^{- 1}$$

$$( coulomb constant ) = 7.607 \; 407 \; 969 \; 385 \; 944 \; 307 \; 421 \; 934 \; 683 \; 512 \; 5 \times {10}^{- 44}$$

$$m ( distance , meter ) = 3.335 \; 640 \; 951 \; 981 \; 520 \; 495 \; 755 \; 767 \; 144 \; 749 \; 2 \times {10}^{- 9} = {( 2.997 \; 924 \; 58 \times {10}^{8} )}^{- 1}$$

$${α}^{+ 1} ( fine \text{-} structure ) = \frac{{e}^{2}}{4 {πɛ}_{o} ℏ c} = \frac{{e}^{2} {μ}_{o} 2 π}{4 π} = \frac{{e}^{2} 4 π 2 π}{4 π} = 2 π {e}^{2} = 0.007 \; 297 \; 352 \; 533 \; 2$$

$${ɛ}_{o} ( permittivity of free space ) = 1 / {μ}_{o} {c}^{2} = {( 9.559 \; 750 \; 795 \; 793 \; 331 \; 736 \; 093 \; 832 \; 519 \; 390 \times {10}^{- 43} )}^{- 1} = 1.046 \; 052 \; 372 \; 453 \; 097 \; 346 \; 175 \; 822 \; 774 \; 076 \; 9 \times {10}^{42}$$

⊚ Quantization Process and Quantized Values of Basic SI Units

How to Turn 7 Fundamental Physical Quantities into Standard Compilation Codes

I. Second (s)

The smallest quantum unit of energy is determined as 1 second based on the property of number “1” and the unit of second itself is defined as dimensionless number “1”. At the center of the theorem of fundamental dimension is the concept of the symbol of second(s).

The quantum number of second(s) is fixed as “1” because it is obviously and inevitably consistent with pure mathematical logic structure and various experimental phenomenalism qualitatively and quantitatively.

Basic SI units are described in the order of length, mass and time. However, <Zero Zone theory> goes in the order of time, length and mass since the concept of time is all the more important.

The concept of time is important because 7 fundamental physical quantities that are measurable in the real world consist of the basic physical quantity of second(s), i.e., energy's smallest quantum unit, given the physical property.

This is to say, 7 fundamental physical quantities consist of the same basic physical quantity of one dimension. This signifies an important message of paradigm shift that 7 fundamental physical quantities, which have been considered to have different semantic dimensions, can be actually compatible and equivalent.

When second(s), the fundamental physical quantity, becomes “1”, it actually becomes the basic physical quantity. The relationship between fundamental physical quantities and basic physical quantity are unified in terms of dimensions and it is now possible to convert all physical quantities into dimensionless numbers according to this concept.

This can be likened to the fact that the basic data unit in computers is byte, yet it consists of bit, the fundamental data unit with the same dimension.

In special theory of relativity, “the speed of photon” is determined as “1” with respect to the concept of invariant speed of light and this explains that second(s), i.e., the time of unit in fundamental physical quantities, is equivalent to the mass or length of 1 photon.

The length of 1 photon is the shortest basic length, equivalent to the wavelength of 1 photon. And this refers to Compton wavelength of 1 photon. Compton wavelength is the simple reverse number of the eigen-frequency. Photon, the smallest quantum unit, uniquely has the attribute of number “1” whose reverse number is 1.

Generally, Compton wavelength of a certain particle equals the reverse number of mass and we can write the following equation in this case.

$$λ = 2 π r = \frac{h}{m \cdot c}$$

Here in the <Stage of existence>, c=h=1(=sec). Thus this simplifies to

$$λ = \frac{1}{m} .$$

And Compton wavelength of photon is

$$λ = \frac{h}{{m}_{ph} \cdot c} = \frac{1}{1} = 2.997 \; 924 \; 58 \times {10}^{8} m = 1$$

Here, mₚₕ is the mass of photon and Compton wavelength (λₚₕ) of photon becomes the speed of light (c) itself.

According to the theorem of fundamental dimension, the equation to explain time(s) and the quantized value are as follows;

λₚₕ=c=1

In terms of special theory of relativity, the law of invariant speed of light points to the property of number “1”, i.e., the concept of energy's smallest quantum unit as can be seen in the foregoing equation.

Based on the qualitative translation and the quantitative value of energy concerning the smallest quantum unit of photon, <Zero Zone theory> unifies the dimension of the qualitative translation of all physical quantities and renormalizes the quantitative values of each physical quantity.

When Planck constant as the fundamental constant of the natural system is defined as the smallest limit of matters, it has the value of number “1” and it has the same dimension with photon quantitatively and qualitatively.

If Planck constant is linked to the energy's smallest quantum unit, photon and defined accordingly, Planck constant will have the same meaning with photon, yet be named differently. Thus, matter obviously has essentially the same dimension with energy.

As new concepts are established regarding the smallest energy quantum unit, all physical quantities including fundamental physical quantities are renormalized and are assigned with the eigen-frequency, which is named as unification constant. As for the physical implication of unification constant, all elementary particles that are observed and measured scientifically and various natural phenomena do have their own eigen-frequency respectively.

II. Length (meter)

As per the theorem of fundamental dimension, the equation of length and the quantized value are as follows;

c=2.99792458×10⁸m=h=1

Thus, m=3.3356409519815204957557671447492×10⁻⁹=(2.99792458×10⁸)⁻¹

People have been confused about the essence of length, i.e., what is length, throughout the history. All the great philosophers, mathematicians and physicists have exerted their efforts to come up with definition or methods to measure length, yet they have not been so successful. The reason is that length is essentially linked to the complex concept of space-time.

In <Zero Zone theory>, the concept of length is inseparable from that of “light” as can be seen in the foregoing equations. In addition, the concept of length is also linked to concepts of energy and quantum in the context of Planck constant, whose interpretation has been deemed difficult in quantum mechanics until today. Refer to the theorem of fundamental dimension for further details

III. Mass (Kilogram)

According to the theorem of fundamental dimension and the 1^{st} invariance equation

$$( \frac{ C m}{V} = {10}^{- 7} ) ,$$

the equation of mass and the quantized value are as follows;

$$\begin{matrix}1 kg = \frac{CV}{{m}^{2}} \\ = 1.356 \; 392 \; 774 \; 181 \; 127 \; 915 \; 890 \; 126 \; 597 \; 759 \; 6 \times {10}^{50}\end{matrix}$$

This figure is the eigen-frequency of mass(kg), which can replace current mass prototype. When this equation is specifically translated, 1 kg refers to 1.3563927741811279158901265977596×10⁵⁰ photons, which is defined in the theorem of fundamental dimension. Mass of “light” (eigen-frequency, frequency) is “1”. Thus, if we represent it in kg,

1/1.3563927741811279158901265977596×10⁵⁰=7.3724957772921866103588570947644×10⁻⁵¹(kg)

In the case of electron, one mass (eigen-frequency, frequency) is as follows;

e(electron mass, eigen-frequency of electron)=1.2355899748687247921557611983726×10²⁰

When mass of one electron is put in kg, we get:

1.2355899748687247921557611983726×10²⁰/1.3563927741811279158901265977596×10⁵⁰=9.1093818721842325060938302819623×10⁻³¹(kg)

If translated on the basis of electron, 1 kg refers to 1.0977693262081037945885935250434×10³⁰(1.3563927741811279158901265977596×10⁵⁰/1.2355899748687247921557611983726×10²⁰) electrons since energy's smallest quantum unit, photon is 1 as per the theorem of fundamental dimension.

In general, <Zero Zone theory> eliminates the barrier of dimensions and converts any particle (atom) including “light” or “electron” into dimensionless number, i.e., eigen-frequency without any unit. In so doing, it is possible to convert them into any physical quantity (fundamental physical quantities, derived physical quantities) including mass (kg) and to represent them in any required physical quantities.

IV. Current (Ampere)

According to the theorem of fundamental dimension and the invariance equation

$$( \frac{ Cm}{V} = {10}^{- 7} ) ,$$

the equation of current and the quantized value are as follows;

$$A = \frac{C}{s} , s = 1$$

Thus, A=C=7.711946866283794025643684684814×10³⁸

A=Ampere (current), C=coulomb (charge), s=second (time)

V. Thermodynamic Temperature (Kelvin)

According to the theorem of fundamental dimension and the 1^{st} invariance equation

$$( \frac{ Cm}{V} = {10}^{- 7} ) ,$$

the equation of thermodynamic temperature and the quantized value are as follows;

$$\begin{matrix}K = \frac{{( \frac{5 {e}^{2} }{3 {v}_{τ} CV} )}^{\frac{9}{5}}}{{( \frac{{k}_{max}}{{k}_{e}} )}^{\frac{1}{7}}} \\ = 2.083 \; 664 \; 363 \; 959 \; 385 \; 424 \; 979 \; 273 \; 593 \; 227 \; 4 \times {10}^{10}\end{matrix}$$

Here, the physical quantities as the parameters forming thermodynamic temperature are as follows;

e (electron mass, eigen-frequency of electron)

v_{τ} (Tau neutrino, which is indicated as the relative quantity to electron in this equation)

CV=C×V=W_{(Watt)}

kₘₐₓ (electron's maximum kinetic energy, which is indicated as the relative quantity to electron in this equation)

kₑ is the physical quantity in

$${k}_{e} = \frac{1}{2} - {v}_{e}$$

and refers to potential energy of electron neutrino)

In the foregoing equation, kₑ and vₑ mark the relative quantity to electron. Thermodynamic temperature is specifically derived in the following process;

By using Planck's value of [symbol] (V) instead of classic value of [symbol] (average energy)=K T, Planck extracted the following equation regarding energy density within blackbody spectrum.

$$pT ( v ) dv = \frac{8 π {v}^{2}}{{c}^{3}} \cdot \frac{hv}{{e}^{- \frac{hv}{κT}} - 1} dv$$

This equation is Planck's blackbody spectrum. According to Planck's hypothesis, matters can only have total energy [symbol] to satisfy the following equation.

[symbol]

=nhv,n=0,1,2,3 \textcircled{2}

Here, v is the frequency and h is universal constant.

When equations \textcircled{1} and \textcircled{2} are combined into [symbol] =v=h=c=1 as per the theorem of fundamental dimension and the sign of differential is removed, we get:

$$= \frac{8 π {v}^{2}}{{c}^{3}} \cdot \frac{hv}{{e}^{- \frac{hv}{κ T}} - 1} = \frac{8 π}{{e}^{- \frac{1}{κ T}} - 1} = 1$$

Equation \textcircled{3} can simplify to:

$$\begin{matrix}\frac{1}{κ T} = ln ( 8 π + 1 ) \\ = 3.263 \; 188 \; 981 \; 367 \; 228 \; 304 \; 363 \; 896 \; 790 \; 104 \; 5\end{matrix}$$

Here k is Boltzmann constant and the following is the equation of this constant;

$$κ = \frac{R}{{N}_{A}} = \frac{{N}_{A} \cdot K}{CV \cdot {N}_{A}} = \frac{K}{CV}$$

R (ideal gas constant)
N_{A} (Avogadro constant)
K (absolute temperature constant)
k (Boltzmann constant)

Here, thermodynamic temperature K results from the quantization based on the theorem of fundamental dimension. That is, absolute temperature unit itself is turned into a constant.

In accordance with the theorem of fundamental dimension, the relationship among these constants can be represented as follows;

CVR=N_{A}K \textcircled{6}

Equation \textcircled{4} can be represented as the following equation, based on equations \textcircled{5} or \textcircled{6}.

$$κ T \cdot ln ( 8 π + 1 ) = \frac{R T}{{N}_{A}} \cdot ln ( 8 π + 1 ) = 1 \\ ∴ R T \cdot ln ( 8 π + 1 ) = {N}_{A}$$

In the foregoing equation, T stands for the temperature used in Planck's blackbody spectrum and this is the temperature specifically fixed as the initial condition when total energy is set as 1( [symbol] =1).

What is notable here is that it is possible to determine the eigen-frequency when we identify the exact values of parameters that form the physical quantities of these constants, in addition to the relationship among Boltzman constant (K), temperature) (K) and Avogadro constant (N_{A}) in the thermodynamic temperature equation and during the quantization process.

In other words, we need to pay attention that physical quantities are not necessarily fundamental or subordinate. Rather, they are inter-related. That is, these physical quantities result from the complex interactions among parameters of physical quantities that are derived from the theorem of fundamental dimension. And following the 1^{st}, the 2^{nd} and the 3^{rd} invariance equations, the equation among major parameters is the 4^{th} invariance equation as follows;

Equation of the Fourth-Invariance

Based on the theorem of fundamental dimension and major parameter physical quantities used for the 1^{st}, the 2^{nd} and the 3^{rd} invariance equations, the 4^{th} invariance equation is derived as follows;

$${[ 3 {v}_{τ} ]}^{\frac{12.6}{7}} \cdot {[ CV ]}^{\frac{19.6}{7}} \cdot [ R ] \cdot {[ {k}_{max} ]}^{\frac{1}{7}} = {[ {k}_{e} ]}^{\frac{1}{7}} \cdot [ {N}_{A} ] \cdot {[ 5 {e}^{2} ]}^{\frac{12.6}{7}}$$

As the physical quantity as the parameter related to 3 types of neutrino appears in the equation of thermodynamic temperature and the 4^{th} invariance equation, we can explain how this physical quantity is related to equations describing 3 types of neutrino as follows;

First of all, the following equations are what <Zero Zone theory> reveals with respect to 3 types of neutrinos for the first time in history.

$$\begin{matrix}{v}_{τ} ( Tau neutrino ) = \frac{np}{{μ}^{2} ( n - p )} & \\ {v}_{μ} ( Muon neutrino ) = \frac{np}{{{μ}^{\frac{8}{3}} ( n - p )}^{2}} & \\ {v}_{e} ( Electron neutrino ) = \frac{np}{{{μ}^{\frac{14}{3}} ( n - p )}^{2}} & \end{matrix}$$

From equations \textcircled{8}, \textcircled{9} and \textcircled{10}, we can derive the physical quantity as the parameter in thermodynamic temperature and the 4^{th} invariance equation as follows;

v_{τ}=kₘₐₓ+k_{τ} \textcircled{11}

v_{μ}=kₘₐₓ−k_{μ} \textcircled{12}

vₑ=kₘₐₓ−kₑ \textcircled{13}

k_{τ} in equation \textcircled{11} refers to potential energy of Tau neutrino.

k_{μ} in equation \textcircled{12} refers to potential energy of Muon neutrino.

kₑ in equation \textcircled{13} refers to potential energy of electron neutrino.

kₘₐₓ in equations \textcircled{11}, \textcircled{12} and \textcircled{13} indicates the maximum kinetic energy of electron.

These equations and physical quantities are defined and discovered by <Zero Zone theory> for the first time.

Equation of the Fifth-Invariance

The 5^{th} invariance equation explains the formal relationship among the theorem of fundamental dimension, lepton, the 1^{st} generation electron and the 2^{nd} and the 3^{rd} generation structures and it is called especially as the 5^{th} invariance equation.

The 5^{th} invariance equation describes 3 types of neutrinos and can be represented in two manners as follows. And particularly the following equation is established among physical quantities that emerge here such as v_{τ}, k_{τ}, v_{μ}, k_{μ}, vₑ, kₑ.

$$\frac{{v}_{τ} - {k}_{τ}}{{k}_{max}} = \frac{{k}_{max} - {v}_{μ}}{{k}_{μ}} = \frac{{k}_{max} - {k}_{e}}{{v}_{e}}$$

We can write equation \textcircled{14} in a different manner as follows;

4(v_{τ}k_{μ}−k_{τ}k_{μ}−v_{τ}vₑ+k_{τ}vₑ+k_{μ}kₑ−v_{μ}vₑ)+2(v_{μ}−kₑ−k_{μ}+vₑ)=0 \textcircled{15}

Equation \textcircled{14} or \textcircled{15} is called the 5^{th} invariance equation, after the 1^{st}, the 2^{nd}, the 3^{rd} and the 4^{th} invariance equations.

General validation method and self-validation mechanism of Standard compilation code as per <Zero Zone theory> are explained.

In <Zero Zone theory>, general validation method checks definitude, determinacy, proof and consistency, etc. of standards. All in all, this is to check if the values of Standard compilation code, i.e., the output of the theory itself, are consistent with experimental values of various major physical quantities and physical constants that natural scientists have repeatedly tested out in labs over time.

Self-validation mechanism is what many preceding mathematicians or physicists have constantly pursued as the ideal validation method throughout the history. As per the self-validation mechanism, the inventor of a theory cross-checks the theoretical integrity while building up the initial integrity of theory. This approach is focused on the integrity of the derivation process itself as well as the conclusion of the theory.

Such a self-validation mechanism is at the core of <Zero Zone theory>, which is deployed for the first time in the world. And this served as the most useful tool in the establishment of the theory at the initial stage.

Standard compilation code unifies the dimensions of different semantic logical expressions and it is equipped with the general validation method as well as the self-validation mechanism. Thus, it successfully offers the highly convenient and precise validation mechanism, overcoming typically complex and difficult validation method.

The following is the validation process of major parameters.

It is previously mentioned that the relationship among Boltzman constant (k) temperature (K) Avogadro constant (N_{A}), etc. should be identified and the parameters forming these physical quantities and their exact values should also be defined as well. If all equations throughout the whole process from \textcircled{1} to \textcircled{15} are correct, the precise and optimized values of physical quantities (modular units), i.e., parameters determining Boltzman constant (k), temperature (K) and Avogadro constant (N_{A}) should consistently satisfy the following equations.

In addition, the quantized values of each physical quantity extracted from the foregoing equations must be strictly consistent with diverse values from lab tests.

$$1. \frac{ Cm}{V} = {10}^{- 7} , {ɛ}_{o} \cdot {μ}_{o} = 1$$

$$2. \frac{{e}^{2 ( x - 1 )}}{{C}^{( x - I )}} = \frac{{V}^{( x + 1 )}}{{m}^{x}}$$

$$3. {α}^{+ 1} = \frac{{e}^{2}}{4 π {ɛ}_{o} ℏ c} = \frac{{e}^{2} {μ}_{o} 2 π}{4 π} = \frac{{e}^{2} 4 π 2 π }{4 π} = 2 π {e}^{2}$$

$$4. = \frac{8 π {v}^{2}}{{c}^{3}} \cdot \frac{hv}{{e}^{- \frac{hv}{κ T}} - 1} = \frac{8 π}{{e}^{- \frac{1}{κ T}} - 1} = 1$$

$$5. κ = \frac{R}{{N}_{A}} = \frac{{N}_{A} \cdot K}{CV \cdot {N}_{A}} = \frac{K}{CV}$$

$${6. [ 3 {v}_{τ} ]}^{\frac{12.6}{7}} \cdot {[ CV ]}^{\frac{19.6}{7}} \cdot [ R ] \cdot {[ {k}_{max} ]}^{\frac{1}{7}} = {[ {k}_{e} ]}^{\frac{1}{7}} \cdot [ {N}_{A} ] \cdot {[ 5 {e}^{2} ]}^{\frac{12.6}{7}}$$

$$7. \frac{{v}_{τ} - {k}_{τ}}{{k}_{max}} = \frac{{k}_{max} - {v}_{μ}}{{k}_{μ}} = \frac{{k}_{max} - {k}_{e}}{{v}_{e}}$$

$$8. 4 ( \begin{matrix}{v}_{τ} {k}_{μ} - {k}_{τ} {k}_{μ} - {v}_{τ} {v}_{e} + \\ {k}_{τ} {v}_{e} + {k}_{μ} {k}_{e} - {v}_{μ} {v}_{e}\end{matrix} ) + 2 ( {v}_{μ} - {k}_{e} - {k}_{μ} + {v}_{e} ) = 0$$

The quantized value of elementary particle contained in the foregoing equation is relative to electron.

The most optimized quantization values derived from each equation while maintaining consistency with various experimental values complete equations. Each equation is quickly and precisely verified through general validation of comparison with actual test results as well as self-validation mechanism.

The following shows major examples of Standard compilation code, which are the quantized values of major physical quantities and elementary particles (including the newly discovered elementary particle) analyzed and calculated from complex relationships among the 1^{st}, the 2^{nd}, the 3^{rd}, the 4^{th} and the 5^{th} invariance equations. (Refer to Physical constants in FIGS. 11 to 19 for further details)

k(Boltzmann constant)=1.3806503348474640088863976247147×10⁻²³

K(absolute temperature constant)=2.0836643639593854249792735932274×10¹⁰

N_{A}(Avogadro constant)=6.0221420085429206443377965254344×10²³

R(ideal gas constant)=8.3144723805937628495834401230083

The quantized values of the elementary particles below are newly discovered through <Zero Zone theory>. These figures are deployed for the calculation of invariance equations and they indicate the relative values to electron. In particular, elementary particles representing potential energy of 3 types of neutrino are newly discovered.

vₑ(electron neutrino)=8.2465028796354755641342196796845×10⁻⁶

kₑ(potential energy of electron neutrino)=0.49999175349712036452443586578032

v_{μ}(Muon neutrino)=0.35256369199283647267198511814953

k_{μ}(potential energy of muon neutrino)=0.14743630860716352732801488185047

v_{τ}(Tau neutrino)=31.201162839906268430116671848600

k_{τ}(potential energy of Tau neutrino)=30.701162839906268430116671848600

VI. Matter Quantity (mol)

According to the theorem of fundamental dimension and the invariance equation

$$( \frac{ Cm}{V} = {10}^{- 7} ) ,$$

the equation of mol and the quantized value are as follows;

$${[ \frac{( \frac{4}{9} \cdot \frac{C}{{e}^{2} ( {α}^{+ 1} )} )}{{( 3 π )}^{\frac{1}{2}}} ]}^{\frac{16384}{19683}} = {{[ \frac{C}{{N}_{A} \cdot {v}_{e} ( e )} ]}^{( \frac{{V}_{u} ( e ) \cdot eV}{C m} )}}^{\frac{- 7}{12}} \\ ∴ {N}_{A} = 6.022 \; 142 \; 008 \; 542 \; 920 \; 644 \; 337 \; 796 \; 525 \; 434 \; 4 \times {10}^{23}$$

vₑ(e), v_{μ}(e) in the equation above refer to the eigen-frequencies of electron neutrino and muon neutrino, rather than the values relative to electron.

In order to explain why the constant has the particular value in determining α⁺¹ (fine-structure constant), the optimization among physical quantities, i.e., various parameters is adopted.

The exponent term on the left side of the foregoing equation

$$( \frac{16384}{19683} )$$

is related to an important physical constant, N_{A} (Avogadro constant). And it is shown that the following equation is established involving N_{A} (Avogadro constant) to determine α⁺¹ (fine-structure constant).

$$1.201 \; 354 \; 980 \; 468 \; 75 = \frac{5.999 \; 999 \; 988 \; 000 \; 000 \; 006 \times 9 C \times {α}^{+ 1}}{ \begin{matrix}1.001 \; 008 \; 575 \; 940 \; 369 \; 676 \\ 391 \; 955 \; 08 \times 9.823 \; 599 \; 263 \; 744 V \end{matrix}} = \frac{11.801 \; 629 \; 901 \; 628}{9.823 \; 599 \; 263 \; 744} = \frac{{3}^{9}}{{2}^{14}} = \frac{19683}{16384}$$

The equation of major parameter physical quantities such as temperature (K) and atmospheric pressure (Pa) is utilized to illustrate the integrity with other experimental constant as a different way of quantization of C (charge), [symbol] (Coulomb constant), V (electric potential) and N_{A} (Avogadro constant).

N_{A}×273.15 K=22.413995862414866245879266415994×10⁻³ m³×101325 Pa

Here,

$$Pa = \frac{C V}{{m}^{3}}$$

VII. Luminosity (Candela)

According to the theorem of fundamental dimension and the invariance equation

$$( \frac{ C m}{V} = {10}^{- 7} ) ,$$

the equation of luminosity and the quantized value based on the definition of candela (cd) are as follows;

$$1 cd = \frac{W}{683} = \frac{C V}{683} = 2.209 \; 649 \; 335 \; 612 \; 525 \; 598 \; 421 \; 916 \; 811 \; 219 \; 6 \times {10}^{30}$$

<Example of Quantum Hall Effect Theory>

According to the theory of quantum hall effect, hall resistance defined as

$${R}_{H} = \frac{{V}_{H}}{I}$$

only takes the value of

$${R}_{H} = \frac{{V}_{H}}{I} = \frac{{R}_{K}}{n} ,$$

Here, n is integer and R_{K} called as von Klitzing has the relation of

$${R}_{K} = \frac{h}{{e}^{2}} = \frac{6.626 \times {10}^{- 34} J \cdot s}{{( 1.602 \times {10}^{- 19} C )}^{2}} = 25813 Ω$$

with basic electron charge e and Planck constant h.

As von Klitzing constant can be measured up to the precision level of 1/10⁹, quantum hall effect is currently used to set the criterion for resistance. As of January 1990, Ohm (Ω) was defined so that R_{K} was exactly 25812.807Ω (written by PAUL A. TIPLER, Physics for scientists and Engineers, translated by Physics textbook publishing committee, Cheongmoongak, 1991).

Physical quantities are converted into dimensionless numbers and then back into the required physical quantities for calculation via Standard compilation code (Zero Zone code). Now, as can be seen below, calculation via Standard compilation code results in the more precise significant figure compared with R_{K} (25812.807Ω), which was defined as of January 1990.

This also illustrates how exact and precise standard setup is important in developing certified measurement devices of electric resistance that can be acknowledged internationally, from industrial engineering perspective.

$${R}_{K} = \frac{h}{{e}^{2}} = \frac{1}{1.5 \; 2 \; 6 \; 6 \; 8 \; 2 \; 5 \; 8 \; 5 \; 9 \; 9 \; 6 \; 0 \; 9 \; 5 \; 9 \; 6 \; 3 \; 4 \; 6 \; 0 \; 4 \; 6 \; 7 \; 5 \; 3 \; 0 \; 6 \; 0 \; 0 \; 8 \times {10}^{40}} = 6.5 \; 5 \; 0 \; 1 \; 5 \; 0 \; 0 \; 3 \; 8 \; 8 \; 6 \; 7 \; 0 \; 6 \; 5 \; 4 \; 7 \; 2 \; 0 \; 4 \; 3 \; 8 \; 1 \; 1 \; 6 \; 3 \; 2 \; 3 \; 8 \; 2 \; 5 \times {10}^{- 41} = \frac{6.6 \; 2 \; 6 \; 0 \; 6 \; 8 \; 7 \; 6 \; 0 \; 0 \; 5 \; 6 \; 6 \; 7 \; 2 \; 4 \; 7 \; 4 \; 5 \; 3 \; 6 \; 6 \; 8 \; 5 \; 7 \; 8 \; 0 \; 7 \; 6 \; 1 \; 6 \times {10}^{- 34} J \cdot s}{{( 1.6 \; 0 \; 2 \; 1 \; 7 \; 6 \; 4 \; 6 \; 2 \; 4 \; 3 \; 2 \; 1 \; 4 \; 6 \; 6 \; 1 \; 3 \; 4 \; 8 \; 1 \; 6 \; 6 \; 4 \; 4 \; 3 \; 0 \; 8 \; 1 \; 1 \; 2 \times {10}^{- 19} C )}^{2}} = 2.5 \; 8 \; 1 \; 2 \; 8 \; 0 \; 7 \; 5 \; 7 \; 2 \; 8 \; 6 \; 9 \; 7 \; 6 \; 5 \; 6 \; 1 \; 9 \; 0 \; 8 \; 2 \; 1 \; 2 \; 3 \; 5 \; 0 \; 3 \; 9 \; 1 \; 9 \times {10}^{4} Ω$$

For your information, Ohm (Ω) is represented as V/C, when dimensions are simplified based on Zero Zone codes.

The limitation of mathematical proof and the proposition of the impossibility of common definition can be overcome through the conversion of the aforementioned physical properties into absolute numbers. And we can rediscover true implication and value of physical quantities and physical constants, which have been only considered as simple physical tools.

⊚ Utility of Self-Validation System as Per <Zero Zone Theory>

<Zero Zone theory> can be precisely validated by comparison with experimental phenomena. In other words, through the comparative analysis of calculation results of <Zero Zone theory> and various physical quantities and physical constants hitherto identified, any laymen can validate <Zero Zone theory> quickly, conveniently and precisely.

In accordance with <Zero Zone theory> equipped with such a solid self-validation mechanism, laymen as well as specialized scientists can quickly and exactly validate any theses with complex equations once they are explained with specific physical quantities. That is, various physical quantities or physical constants on the left and the right sides of equations are converted into dimensionless numbers as per <Zero Zone theory> and calculated accordingly. Then if this calculation result equals the numbers in the theses is checked.

Such a requirement for the validation system has been inevitably raised whenever new theories have been published throughout the history. Now, scientists as well as laymen can resolve decades-old disputes over the validation of new theories. This signifies the important turning point in the history of science in that scientific validation is no longer the sanctuary of scientists.

The great Nobel laureate <Weinberg> once offered a clear-cut answer to the question of how a new theory could be quickly validated, which we needed to heed.

^{┌}I'm certain that the theoretical foundation of the values of all physical constants will be found. The theory to explain everything will come up. And for its validation, we can observe if this new theory is exactly consistent with physical constants in the previously measured standard models._{┘}

His remark here predicted the quick validation mechanism of theories. And this can be applied to the theory explaining everything and also to general theories once they are stated with specific physical quantities. And scientists today persistently look for the aforementioned format of theses.

Despite all that, various fields of natural science are causing huge side-effects (disputes over the theoretical authenticity, etc.) since such a formal structure has not been found. In all ages and countries, scientists have pursued the new validation mechanism to put an end to the long-standing arguments over scientific validation.

Here, let's discard the prevailing concept among general public of physical constants that they are difficult. Before <Zero Zone theory>, it was true that physical constants were understood as the combination of complex and huge numbers with strange units (you can visualize that physical constants=numbers+units).

Now, we can view physical constants from the perspective of simple syntax, rather than that of complex semantics of physicists. In so doing, physical constants are no longer the combination of fundamental physical quantities or derived physical quantities that only physicists understand. Physical constants are no other than the simple numeric combination of energy's smallest quantum unit.

As per <Zero Zone theory>, any theory can be validated if numeric values are attached to strange units that accompany individual physical quantities. Now, we can confidently say that the most logical expression requiring the smallest energy is number. And at the same time, we can realize the amazingly specific utility of the property of abstract number “1” in the context of the real world we live in.

⊚ Standard Compilation Code as Per <Zero Zone Theory>

1. Overview

The concept of Standard compilation code (Zero Zone code) as per <Zero Zone theory> can be expanded to the database that defines the compatibility between dimensionless numbers and the dynamic equations of nature extracting the numbers.

For example, if there's an equation between dimensionless number ‘N’ and nature's dynamic equation ‘F(A, B, C, D)’ about physical quantities A, B, C and D as below, Standard compilation code is the database itself matching the dynamic equation of ‘F(A, B, C, D)’ and dimensionless number ‘N’ in an 1 to 1 relation.

For reference, nature's dynamic equations represent mathematical logic expressions where natural phenomena are accounted for in parameters of physical quantities. Thus, the structural combinations of parameters representing physical quantities, the equations of dimensionless numbers or the equations among basic unit, physical constants or various properties of elementary particles and dimensionless numbers are all examples of nature's dynamic equations.

F(A,B,C,D)=N

Furthermore, Standard compilation code contains the database mapping nature's dynamic equation ‘Operation{F(A, B, C, D)}’ and dimensionless number ‘Operation{N}’ based on the repeated mathematical operations of regular patterns between the right and the left sides of the foregoing equation.

Operation{F(A,B,C,D)}=Operation{N}

For the convenience of explanation, dimensionless number ‘N’ subject to mathematical operations is called as mother number whereas dimensionless number ‘Operation{N(dimensionless number)}’ as the result of mathematical operations is called as child number. And the equation before mathematical operations is named as mother equation and the equation after mathematical operations as child equation.

In order to generate child numbers from the foregoing mother numbers, the following mathematical operations are executed upon the left and the right sides of mother equation and we subsequently get child equation. However, the present invention is not confined to this. Any mathematical operations with the specific pattern can be applied. Now, when mathematical operations with regular patterns are applied to nature's dynamic equations or dimensionless numbers, this is called as quantization of nature's dynamic equations or dimensionless numbers.

(1) k is multiplied by the left and the right sides of mother equation so that nature's dynamic equation and dimensionless number are quantized. k equals a/b. Yet, a and b are randomly selected from the set of integers from 1 to n and input in the equation. The upper limit of n is arbitrarily set. The permutation of k is n².

kF(A,B,C,D)=kN

(2) By raising the right and the left sides of mother equation to the power of k, we can quantize nature's dynamic equation and dimensionless number. k is a/b. a and b are randomly selected from the set of integers from 1 to n. However, 0 cannot be input as a numerator. The upper limit of the absolute value of n is randomly set. The permutation of k is (2n+1)(2n−1).

F(A,B,C,D)^{k}=N^{k}

(3) When the left and the right sides of mother equation are raised to the power of k and multiplied by p, nature's dynamic equation and dimensionless number are quantized. k is a/b. a and b are randomly selected from the set of integers from −n to n. However, 0 cannot be input as a numerator. The upper limit of the absolute value of n is randomly set. The permutation of k is (2n+1)(2n−1). p is a/b. Yet, a and b are randomly selected from the set of integers from 1 to n and input in the equation. The upper limit of p is randomly set. The permutation of p is n².

F(A,B,C,D)^{k}p=N^{k}p

(4) The left and the right sides of mother equation are multiplied by 10^{k} and nature's dynamic equation and dimensionless number are quantized. k is a/b. a and b are randomly selected from the set of integers from −n to n and input accordingly. However, 0 cannot be input as a numerator. The upper limit of the absolute value of n is randomly set. The permutation of k is (2n+1)(2n−1).

10^{k}F(A,B,C,D)=10^{k}N

(5) The right and the left sides of mother equation are subject to In or Log operation and nature's dynamic equation and dimensionless number are quantized.

In{F(A,B,C,D)}=InN

Log {F(A,B,C,D)}=Log N

(6) The left and the right sides of mother equation are multiplied by π^{k} and nature's dynamic equation and dimensionless number are quantized. k is a/b. a and b are randomly selected from the set of integers from −n to n and input accordingly. However, 0 cannot be input as a numerator. The upper limit of the absolute value of n is randomly set. The permutation of k is (2n+1)(2n−1).

π^{k}F(A,B,C,D)=π^{k}N

(7) The left and the right sides of mother equation are multiplied by e^{k} and nature's dynamic equation and dimensionless number are quantized. k is a/b. a and b are randomly selected from the set of integers from −n to n and input accordingly. However, 0 cannot be input as a numerator. The upper limit of the absolute value of n is randomly set. The permutation of k is (2n+1)(2n−1).

e^{k}F(A,B,C,D)=e^{k}N

Through the foregoing quantization, multiple child equations can be derived from one mother equation. And Standard compilation code is established as the database of mapping the left and the right sides of each child equation in an 1 to 1 relation.

(8) Furthermore, when multiple mother equations are combined through permutations and all possible operations (+, −, ×, ÷) are applied to the resulting mother equations, we get new mother equations. And if any one of the foregoing mathematical operations (1) to (7) is applied to the left and the right sides of equations, we obtain multiple child equations. The 1 to 1 mapping database of the left and the right sides of each child equation can be further included as the scope of Standard compilation code. Let's take a look at the example of how 3 mother equations are applied.

3 Mother Equations

F(A,B,C,D)=N \textcircled{1}

G(B,C,D,E)=M \textcircled{2}

H(A,B)=P \textcircled{3}

Mother equations are extracted by applying 4 fundamental operations to the permutations of the foregoing 3 mother equations

FGH=NMP \textcircled{4}

F/G/H=N/M/P \textcircled{5}

(F+G+H)=N+M+P \textcircled{6}

(F+G)×H=(N+M)×P \textcircled{7}

When multiple mother equations (\textcircled{4} to \textcircled{7}) are derived from the 4 fundamental operations as above, we can obtain multiple child equations by applying any one of mathematical operations of (1) to (7) to the left and the right sides of each mother equation. The database structure of mapping the left and the right sides of each child equation derived therein can be included in the scope of Standard compilation code.

And as for the mathematical operation of (8) above, we can derive mother equation by raising the left and the right sides of equations \textcircled{1}, \textcircled{2} and \textcircled{3} subject to the 4 fundamental operations to the power of k and executing the mathematical operations of \textcircled{4} to \textcircled{7}. Here, when raising the left and the right sides of equations \textcircled{1}, \textcircled{2} and \textcircled{3} to the power of k, k is not necessarily the same. k is a/b. a and b are randomly selected from the set of integers from −n to n and input accordingly. However, 0 cannot be input as a numerator. The upper limit of the absolute value of n is randomly set.

The following table is the example of how Standard compilation code is structured as above. The exemplified Standard compilation code is the table of relational database. The relational database of Standard compilation code can be built with commercialized mass database technologies such as Microsoft's SQL server, Oracle database server, interface server, Linux MySQL server, etc. However, the invention here is never confined to the aforementioned technologies.

When referring to the following table, tables containing Standard compilation code include the field for dimensionless number of mother equation (mother_number), the field for reference code of mother equation (equation_address), the field for mathematical operations deployed to extract child equations out of mother equations (mathematical_operation) and the field for dimensionless number (child number) resulting from the mathematical operations on the dimensionless number (mother number) of mother equations (child_number); Alternatively, the aforementioned ‘equation_address’ can directly store nature's dynamic equations, rather than reference code of mother equations and this is obvious to the persons concerned.

| mother_number | eqation_address | mathematical_operation | child_number |
|---|---|---|---|
| . | . | . | . |
| . | . | . | . |
| . | . | . | . |
| 137.035999761613 | 16-904 | \hat{ } ((3 \hat{ } 3)1(2 \hat{ } 17)) | 1.0010140527668 . . . |
| 137.035999761613 | 16-904 | \hat{ } ((2 \hat{ } 2)/(3 \hat{ } 9)) | 1.0010003971654 . . . |
| 137.035999761613 | 16-904 | \hat{ } (1/10) | 1.6356239728718 . . . |
| 137.035999761613 | 16-904 | \hat{ } ((2 \hat{ } 41)/(3 \hat{ } 33)) | 1.0019482188206 . . . |
| 137.035999761613 | 16-904 | \hat{ } ((3 \hat{ } 85)/(2 \hat{ } 146)) | 1.0019830979417 . . . |
| 137.035999761613 | 16-904 | \hat{ } ((2 \hat{ } 82)/(3 \hat{ } 59)) | 1.0016852250728 . . . |
| 137.035999761613 | 16-904 | \hat{ } ((2 \hat{ } 87)/(3 \hat{ } 62)) | 1.0019976153055 . . . |
| . | . | . | . |
| . | . | . | . |
| . | . | . | . |

Preferably, the foregoing table needs to be built as clustered index structure. In this case, we can speed up the search of dimensionless numbers stored in tables. The technology of building database based on the foregoing clustered index structure is already notified to the persons skilled in the art. So, the detailed explanation is skipped here.

In other examples, Standard compilation code can be produced in the format of files where the separator “;” is used. For instance, ‘mother_number; equation_number; mathematical_operation; child_number’ can be used as the repeating unit to make up Standard compilation code.

In addition to the aforementioned examples, if database allows cross-reference of nature's dynamic equations and the corresponding dimensionless numbers, we can establish Standard compilation code. Therefore, the mechanism of the 1 to 1 mapping of the left and the right sides of nature's dynamic equations via dimensionless numbers is not confined to the aforementioned. Accordingly, it is also possible for the persons concerned to come up with diverse variations.

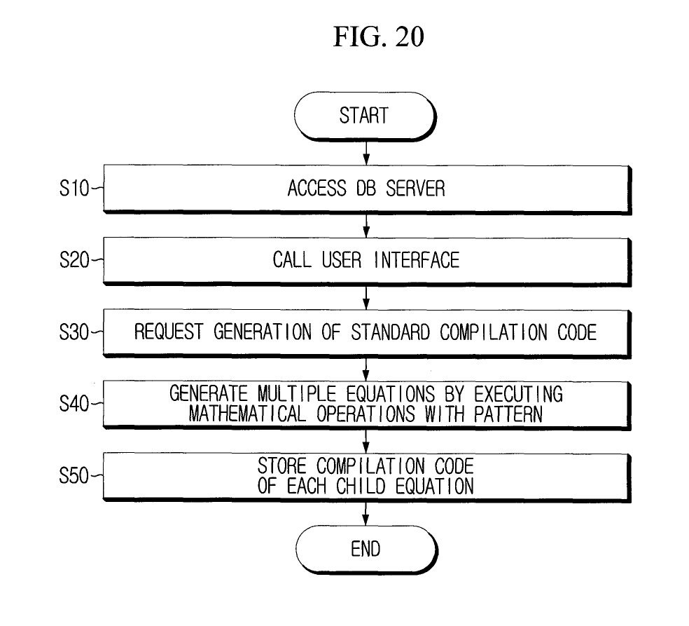

FIG. 20 is the high-level process flow of establishing Standard compilation code in the format of database. The following process can also be applied to the process of producing the file-type Standard compilation code.

When FIG. 20 is referred to, the client where Standard compilation module is mounted is used for the access to the database server via network (step S10). Here, the connectivity between the client and database server is compliant with standard network topology.

Then, user interface of Standard compilation code module is called (step S20). User interface allows the input of reference code of nature's dynamic equations into the left side of mother equation and the input of dimensionless number into the right side of mother equation. Preferably, the aforementioned user interface is GUI (Graphic User Interface). Selectively, the user interface here can offer the interface where nature's dynamic equations themselves can be entered.

Then, the builder of Standard compilation code enters reference code of mother equation and dimensionless number via the established interface and requests the generation of Standard compilation code to the database server (step S30). Selectively, the builder of Standard compilation code can additionally input nature's dynamic equations included in mother equation.

On the other hand, the database server contains Standard compilation code generation module. Upon the request for Standard compilation code generation, this module applies the pre-defined patterns of mathematical operations (Refer to (1) to (7) of 1. Overview) to data input by the builder of Standard compilation code and generates multiple child equations. When Standard compilation code is produced for each generated child equation, it is stored in the database (step S50). It is desirable to repeatedly conduct the foregoing steps S20 to S50 for the various dynamic equations of nature that are theoretically or experimentally analyzed.

On the other hand, even if not shown in the drawings, the foregoing module of Standard compilation code can offer user interface to support the input of dimensionless numbers and reference codes of multiple dynamic equations of nature. Through such a user interface, permutations and combinations of multiple dynamic equations of nature and application of all types of operations (+, −, ×, ÷) among the resulting equations can be supported so that new mother equation is produced (Refer to mathematical operation method explained in (8) of 1. Overview) and Standard compilation code is generated and stored for each resulting mother equation via steps S40 and S50.

The utility of Standard compilation code here is proportionate to the number of nature's dynamic equations processed as Standard compilation code. Accordingly, it is desirable to continuously update Standard compilation code.

Standard compilation code can be useful for the quantitative and the qualitative interpretation of nature's dynamic numbers expressed as dimensionless numbers. That is, if nature's dynamic physical quantities are obtained experimentally or theoretically, the resulting physical quantities can be checked through Standard compilation code after conversion into dimensionless numbers as per <Zero Zone theory>. In so doing, we can verify the concerned dynamic equation for the dimensionless numbers. This allows the quantitative and the qualitative interpretation of nature's dynamic physical quantities that are obtained experimentally or theoretically. Preferably, such a translation needs to be implemented automatically via the programs linked to Standard compilation code.

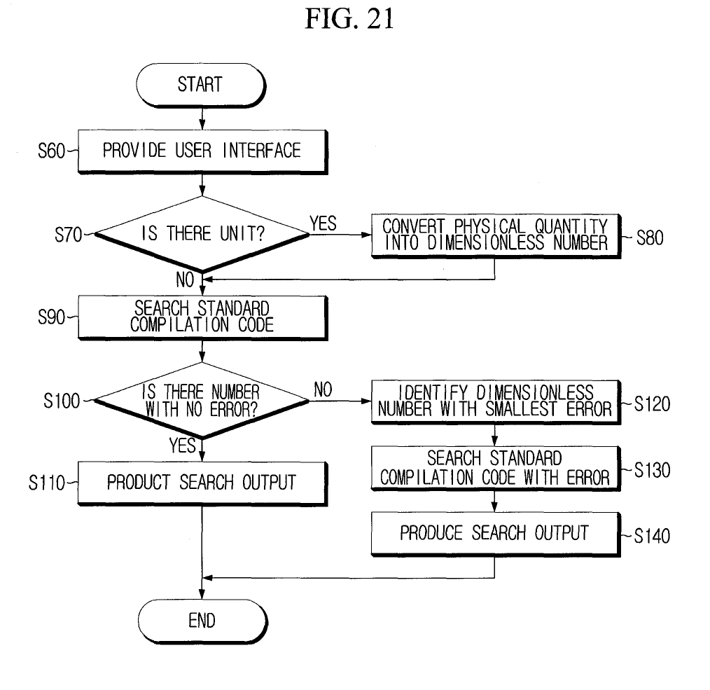

FIG. 21 is the process flow that explains the quantitative and the qualitative translation process of nature's dynamic physical quantities that are converted to dimensionless numbers in accordance with <Zero Zone theory>. Here, FIG. 21 shows the process of the numeric value translation program that is linked to the established Standard compilation code.

As in FIG. 21, user interface is offered so that the physical quantity subject to translation is input upon user request (step S60). The foregoing physical quantity can be expressed as a standard unit in <Metric system> or a dimensionless number as per <Zero Zone theory>. Preferably, the user interface above is GUI.

And when the user requests analysis after input of the concerned physical quantity, if the physical quantity contains a unit is checked (step S70). If there's a unit attached, the original unit included in the physical quantity is replaced with Zero Zone code as per <Zero Zone theory> so that the physical quantity becomes dimensionless (step S80) and this proceeds into step S90. When there's no unit attached, we directly move to step S90.

In step S90, the dimensionless physical quantity is used as key to search Standard compilation code. ‘child number’ field is searched. Then, if a dimensionless number exists without any error is determined (step S100).

If a dimensionless number without any error exists, Standard compilation code is inquired for the identification of the record containing the concerned dimensionless number. And mother number (mother_number), reference code of nature's dynamic equation (equation_address) and mathematical operation method (mathematical_operation) are extracted from the specific record and such search results are output to the user (step S110).

### Output Example

4.4368740563618544990834786089658e+42=(P-197-4-1-10)̂97*55=(2.64069781000404991)̂97*55

In the foregoing example, ‘4.4368740563618544990834786089658e+42’ is the physical quantity that is converted to a dimensionless number. ‘P-107-4-1-10’ is the reference code of the nature's dynamic equation related to this physical quantity. And ‘̂97*55’ is the mathematical operation method to extract ‘4.4368740563618544990834786089658e+42’ out of the nature's dynamic equation, which is identified as ‘P-107-4-1-10’. ‘2.64069781000404991’ is the dimensionless number that corresponds to the nature's dynamic equation identified as ‘P-107-4-1-10’. Given the foregoing output example, when the dynamic equation of ‘P-107-4-1-10’ is raised to the power of 97 and is multiplied by 55, we obtain the number that comes up from the DB search. Furthermore, when nature's dynamic equations of ‘P-107-4-1-10’ and the mathematical operation method are thoroughly analyzed, we can quantitatively and qualitatively translate ‘4.4368740563618544990834786089658e+42’, i.e., the physical quantity without dimension.

However, if there's no matching dimensionless number without errors, the dimensionless number with the smallest error between the dimensionless numbers greater and smaller than the concerned physical quantity is searched. (step S120)

Let's call the dimensionless number with the smallest error among dimensionless numbers greater than the concerned physical quantity as ‘dimensionless number_{large}’ and call the dimensionless number with the smallest error among dimensionless numbers smaller than the concerned physical quantity as ‘dimensionless numberₛₘₐₗₗ’.

Now, this is the equation between the searched ‘dimensionless number_{large}’ and ‘dimensionless numberₛₘₐₗₗ’ and the concerned ‘dimensionless number search’. E1 and E2 here represent the magnitude of errors.

‘dimensionless number_{search}’=‘dimensionless number_{large}’×E₁(0<E₁≦1)

‘dimensionless number_{search}’=‘dimensionless numberₛₘₐₗₗ’×E₂(1≦E₂)

Then, E₁ and B₂ are respectively used as search keys for Standard compilation code. As a result, we get the dimensionless number with the smallest error compared with E₁ and E₂. (step S130)

E₁=dimensionless number₁×E₁′

E2=dimensionless number₂×E₂′

Now, the following equation can be written.

‘dimensionless number_{search}’=‘dimensionless number_{large}’×dimensionless number₁×E₁′(0<E₁′≦1)

‘dimensionless number_{search}’=‘dimensionless numberₛₘₐₗₗ’×dimensionless number₂×E₂′(1≦E₂′)

Then, Standard compilation code is inquired to identify records that correspond to ‘dimensionless number_{large}’, ‘dimensionless number₁’, ‘dimensionless numberₛₘₐₗₗ’ and ‘dimensionless number₂’ respectively. And the reference codes of nature's dynamic equations, mathematical operation methods and mother numbers in the concerned records are extracted and the following results are output to users (step S140).

### Output Example

$$Small Difference \text{:} 1.00000000000 \; 1 \; 1 \; 3 \; 3 e + 0 \; 0 \; 4.4 \; 3 \; 6 \; 5 \; 9 \; 2 \; 5 \; 0 \; 9 \; 6 \; 3 \; 9 \; 9 \; 7 \; 9 \; 2 \; 5 \; 6 \; 4 \; 6 \; 2 \; 5 \; 15 \; 8 \; 1 \; 1 \; 2 \; 7 e + 4 \; 2 = [ {( P - 197 - 4 - 1 - 10 )}^{⋀} 97 * 55 ] * [ {( S 126 - 47 - 9 )}^{⋀} 89 / 26 ] = [ {( 2.64067981000404991 e + 0 \; 0 )}^{⋀} 9 \; 7 * 5 \; 5 ] * [ {( 1.0 \; 0 \; 0 \; 0 \; 0 \; 5 \; 6 \; 0 \; 9 \; 3 \; 8 \; 6 \; 8 \; 7 \; 0 \; 1 \; 1 e + 0 \; 0 )}^{\hat{}} 89 / 26 ] \\ large Difference \text{:} 1.0 \; 0 \; 0 \; 0 \; 0 \; 0 \; 0 \; 0 \; 0 \; 0 \; 0 \; 0 \; 0 \; 00 \; 6 \; 7 e + 00 \; 4.4 \; 3 \; 6 \; 5 \; 9 \; 2 \; 5 \; 0 \; 9 \; 6 \; 3 \; 9 \; 9 \; 7 \; 9 \; 2 \; 5 \; 6 \; 4 \; 6 \; 2 \; 5 \; 1 \; 5 \; 8 \; 1 \; 1 \; 2 \; 7 e + 4 \; 2 = [ {( S 3 \; 1 - 2 \; 5 - 4 )}^{\hat{}} 1 / 1 * 1 / 1 ] * [ ( A - 202 - 12 - 1 - 1 ) * {( 6 \; 1 / 8 \; 8 )}^{\hat{}} - 1 ] = [ {( 4.4 \; 3 \; 6 \; 9 \; 5 \; 9 \; 2 \; 5 \; 0 \; 9 \; 6 \; 4 \; 0 \; 0 \; 0 \; 1 \; 0 )}^{\hat{}} 1 / 1 * 1 / 1 ] * [ ( 1.4 \; 4 \; 2 \; 6 \; 2 \; 2 \; 9 \; 5 \; 0 \; 8 \; 1 \; 9 \; 66 \; 9 \; 9 \; 6 ) * {( 6 \; 1 / 88 )}^{\hat{}} - 1 ]$$

The user can do the translation based on the foregoing output examples as follows; That is, the physical quantity subject to analysis ‘4.43659250963997925646251581127e+42’ is related to the dynamic equation of ‘(P-197-4-1-10)̂97*55’ where mathematical operation of ‘̂97*55’ and also related to the equation of ‘(S126-47-9)̂89/26’ where mathematical operation of ‘̂89/26’ is applied. The error of dividing the left side by the right side of the equation (E1′ or 1/E1′) is ‘1.000000000001133e+00’.

And the physical quantity subject to analysis ‘4.43659250963997925646251581127e+42’ is also related to the dynamic equation of (S31-25-4)̂1/1*1/1′ and ‘(A-202-12-1-1)*(61/88)̂-1’ and the error of dividing the right side by the left side of the equation (E2′ or 1/E2′) is ‘1.00000000000000067e+00’.

When the user does the in-depth analysis of nature's dynamic equations identified via reference codes and the concerned mathematical operation methods, the physical quantity—turned dimensionless number ‘4.43659250963997925646251581127e+42’ can be quantitatively and qualitatively translated.

If the foregoing error adjustment is conducted, the quantitative and the qualitative translation of the physical quantities can be made ultra-precise. And the error adjustment above can be further executed to enhance the preciseness of the quantitative and the qualitative translation, which is obvious to the persons concerned.

As for the foregoing example of the translation of physical quantity, nature's dynamic equation is not directly presented and only the reference code is provided. However, if nature's dynamic equation is stored in Standard compilation code, the reference code can be replaced with the concerned dynamic equation and displayed to the user.

In terms of output of the translation of physical quantities, if nature's dynamic equation is only given by reference code, the user is preferably given the codebook to look up for the dynamic equation based on reference code. Such a codebook can be provided as published media and can also be included as the references in the numeric value translation program that is driven by the present invention.

The foregoing numeric value translation program can be loaded onto the server computer. In this case, the user accesses the server above via network from the client and calls the user interface offered by the numeric translation program for the quantitative and the qualitative analysis of physical quantities related to natural phenomena.

In this case, the network above can be anything such as wired/wireless LANs, wired internet, wireless internet, satellite communications, wired/wireless telephony, cable communications, ubiquitous communications network, etc., if it is based on the server-client model in the field of the technology the present invention is related to.

As is well-known, the biggest challenge before quantum physics today does not lie in how test results are processed from mathematical physics perspective, but in how they are translated. The implication of the present invention is that the groundwork for the resolution of the challenge in modern quantum physics is laid via the comparative analysis between the strictly defined physical quantities, converted dimensionless numbers and the dimensionless numbers of the physical quantity subject to interpretation.

And the present invention is consistent with what many preceding great physicists have predicted.

<Eugene Wigner, Nobel Physics Laureate>

[symbol] The essential goal of physicist is to attach ‘numbers’ to ‘physical quantities’ and to identify the mutual relationship therein.

[symbol]

<Feynman, Nobel Physics Laureate> [symbol] In the next era of the great awakening of human intelligence, we'll come up with the understanding of the qualitative contents of equations. Now, we cannot. In order to reach the next era of the great awakening, we need be rescued from the devil of dimensions (units).

[symbol]

<Martin Rees, Professor of Mathematics at Kings College, Cambridge>

[symbol] The day will come when physical forces and constants are computed in abstract mathematics principle, rather than experimental measurements. This may not be easy at all. Yet, that day will come just as circumference is calculated from diameter.

[symbol]

<Steven Weinberg, Nobel Physics Laureate>

[symbol] I'm certain that the theoretical foundation of the values of all physical constants will be found. The theory to explain everything will come up. And for its validation, we can observe if this new theory is exactly consistent with physical constants in the previously measured standard models.

[symbol]

⊚ Expansion into Computer Operating System as Per <Zero Zone Theory>

1. Computer Language and Invariance Equations of Physical Quantities

Computer programs use the format of numbers to express different data while maintaining the format. For instance, arbitrary numbers are assigned to the alphabet symbols off, a, t, h, e and r, to display ‘father’.

The problem is that numbers can be confusing for the expression of numbers themselves as numbers are used for letter symbols. Thus, numbers are arbitrarily assigned to 0, 1, 2, 3, 4, 5, 6, 7, 8 and 9 as well. For example, the number representing letter (a) is ASCII code 97 and that for number ‘1’ is ASCII code 49. Likewise, data expression in computer language requires a different structure to avoid any further confusion.

Here, numbers representing the symbols of letters and numbers are arbitrarily set. Thus, data input for complex syntax and rules, etc. is needed so that computers can understand input data for processing. Besides, various difficulties should be overcome to get the necessary data output.

Program language in <Zero Zone theory> does not adopt the approach of assigning arbitrary numbers above. Rather, it takes the approach of using repeating numeric values in natural system as units themselves.

So far, even fundamental physical quantities have gone through the complex process of conversion into the arbitrarily defined numbers as above. However, in <Zero Zone theory>, the eigen-frequencies that emerge in natural system based on invariance equations are utilized. As a result, the framework is set where numbers only can represent the meaning and the quantity of numeric values and symbols (units) of fundamental physical quantities.

Invariance equations derived as per <Zero Zone theory> show that invariant numeric values do exist among fundamental physical quantities that are expressed via arbitrarily defined numbers and unit symbols and that the arbitrarily set numeric values and letter symbols do not matter at all.

Thus, invariance numbers here can replace invariance equations. By using the invariance numbers, physical quantities combining numeric values and unit symbols can be represented only via numbers. Such a representation approach means that invariance numbers work as if they are basic units. For example, there are 2π, 3π and so on when π is an invariance number. Likewise, all physical phenomena and the related constants can be unified into numeric values that simultaneously imply the meaning as well as the quantity.

If this representation method is adopted, we don't have to assign arbitrary numbers as we do now. Numeric values observed in actual natural phenomena are input into computers and operations and interpretation can be done without a separate compilation process.

And during the process of output, numeric value translation method can be applied based on Standard compilation code. By doing so, we can naturally extract the meaning of numbers and further utilize computer data systems. Especially, if the foregoing data processing mechanism is deployed to the fields of scientific technology, we can enhance the operation speed.

2. Physical Properties and Computer Language

When calculation is possible in computers, it means that the object of calculation is a logical proposition that allows strict logical description. As the object of pure mathematical theories, the logical proposition refers to physical properties in the field of science.

Physical properties are theoretically defined as the minimum unit that can be mathematically calculated. For example, we can take physical quantities that human beings have defined to enable exact communications and this can be considered as the physical property that can be commonly agreed upon. At present, we need to notice that only physical quantities with the same dimension can be mathematically calculated and computers also are not without this limitation.

The unit of kilogram (kg) can be calculated with the unit of kilogram (kg), yet not with temperature (K). This means that it is impossible to infer the logical relationship between different physical properties (physical quantities as the logical representation with different semantic dimensions such as physical property of mass and that of temperature) quantitatively or qualitatively.

As it is impossible to derive the mutual relationship, computer operations and controls are not allowed and this theoretically leads to incomputability of computers. Computer calculation is not beyond the scope of simple arithmetic calculation. Thus, additional logical reasoning is needed for the qualitative translation of calculation results.

This is the true goal of output as the last step of computer calculation. The series of calculation process in computers takes place in the engineering system based on the control of simple electric signals. The problem is that the calculation and the reasoning of the result can only be obtained when human beings externally design the algorithm in accordance with the logical structure of computer languages.

In other words, computers as machines do not judge or recognize. We human beings build specific symbols with syntax required for input in computers and computers mechanically understand and infer the specific symbols based on the pre-defined logical structure and/or rules. High-level languages are the example of the pre-defined symbols and computers read symbols as the output in accordance with the designated rules.

We need to note that computers have the simple quantitative calculation function and also the function of qualitative logical reasoning to link the meaning to the propositions as computer languages have syntax. Computer languages that are generally used are high-level languages and actual programmers use structured English rather than standard English. Thus, structured English here has the regular syntax to allow strict logical description and reasoning.

All computer languages are equipped with strict syntax, allowing broad translation to commit to the physical properties in the regular patterns of nature. In that sense, they can be categorized along with physical quantities as the fundamental language to extract regular physical system in natural science.

Actually, many computer scientists are making efforts to come up with universal syntax that consists of the minimum number of parameters to realize minimalist program of computer language. Linguists assume parameters as the core unit component commonly included in the syntax of various languages in the world and they are trying to identify the common parameter. Likewise, if we can translate the parameters or exactly identify the values, various languages can be compiled via simple combination of several parameters. And we can also identify the regular syntax, i.e., invariant structure among languages. In so doing, we'll be able to establish ideal computer programming language based on the minimum unit components, which will render computer calculation extremely simple and allow us to build the system without bugs or errors.

Keep in mind that natural science today expresses and interprets various natural phenomena as physical quantities, which are logical representation of different semantic dimensions. When natural phenomena are expressed in physical quantities, we mean the expressions of physical equations that we all know. This is an effort to display the way natural phenomena emerge in the commonly recognizable algorithms for everyone. This is possible since we've defined the physical properties in every individual natural phenomenon and indicated them as pre-designated symbol (physical quantity).

Pre-definition of physical attributes here is essential to obtain the exactness and comparability of measurements. Especially in modern science where exact information is required, data is extracted via the tool of computers. In this sense, computer languages and syntax as data input method of computers are inevitably related to the definition, i.e., commonly defined physical properties.

Unfortunately, current computer language consists of syntax that human beings have arbitrarily created, thereby not having any relationship with the definition of physical properties. Accordingly, it is so natural that operation and reasoning of the operation results are executed separately.

This also means that input method inherently gets highly complex in order to produce the required output in accordance with the logical circuit via general computer languages, in terms of operation and control. This is the 1^{st} priority challenge in computer science or engineering today. This all results from the extremely difficult and complex input method for the required output in computer languages

Especially, complex dimensions in computer calculation make logical circuit in computer operation and control all the more complex. And errors from input values that are empirically obtained (statistical errors, structural errors) get accumulated so that computer utilization for the purpose of exact or precise calculation is fundamentally limited. This tends to trigger errors and bugs in computer calculation in many cases.

In the wake of the inherent limitation due to increasingly complex logical circuit, the effort and the technology to physically speed up operation or expand memory capacity are required for the exact output, which is to accomplish the purpose of computer processing. We need to note that the hardware-oriented approach to simply speed up machine power and increase memory capacity as this originates from lack of in-depth and structural perspective about physical properties and common agreement thereof.

As for the analysis process based on the aforementioned Standard compilation code, it is notable that numbers without dimensions are input. As <Zero Zone theory> proves that numbers related to natural phenomena can be equivalent to nature's dynamic equations, we can generalize such points into the computer programming language for operations of natural science. In so doing, we will be able to extract the program language that is obviously differentiated from other general computer languages with complex syntax, even in terms of input process. Conveniently, the program language that can be extracted accordingly is called <Zero Zone language>.

Given its nature of dimensionless numbers, <Zero Zone language> can be used as a highly useful algorithm as well as a program for calculation and measurement in industrial engineering. <Zero Zone language> uses Zero Zone code that is based on invariance equations, which are derived from the combination of unit physical quantities, i.e., parameters. Zero Zone code is obtained via conversion and unification of physical quantities with different dimensions into the dimension without any units. By utilizing Zero Zone code, we can convert physical quantities into numeric values and input them. Thus, the complex logical operation required for computers to interpret high-level languages can be saved. In so doing, it is possible to maximize the advantage of computing power such as calculation and memory.

In addition, cross-calculation among physical quantities with different dimensions is allowed. When Standard compilation code is referred to, numbers input or derived from calculation can be qualitatively translated, highly simplifying program design. Accordingly, relative operation speed, instead of typical physical processing speed can be enhanced. Besides, as number of bits unit area can be highly utilized, calculation as well as control of computing power can be maximized, resulting in exponential growth of computer capacity.

Generally speaking, computer science or computer engineering pursues the qualitative growth of computer's operation speed, rather than the quantitative growth thereof. In other words, the qualitative enhancement of software instead of hardware is sought after.

There have been numerous qualitative developments in terms of accessory functions such as graphic, document editing, search, compression, etc., yet without fundamental solution nearby. We can say that general PCs with various program languages and OS are halfway there in the pursuit of the ultimate goal. Computer scientists point out that existing computer languages can only utilize 5% of the theoretically possible computing power.

3. Zero Zone O/S

The essential function of computers is not about document edit, graphic or access to other hardware (device drive), etc., but about comparative computation.

It is possible to generalize and translate the input method, the operation method and the output method in the Standard compilation code-driven quantitative and qualitative translation into computer operating system.

In other words, unlike general computer languages that require input of physical quantities based on complex syntax rules, the new operating system requires input of numeric values only so that computer CPU can focus on operation processing and the numeric value entered is a significant figure that has already unified dimension. All this brings about the effect of maximizing computer control and memory capacity in the new computer operating methodology.

In addition, structured translation of nature's dynamic equation (equation equals algorithm) is done via Standard compilation code during the output process. This means that the new operating system offers intelligent translation of nature's dynamic equations as well.

The system with the algorithm that allows compatibility between the series of language letters (standard units) and numeric values can be viewed as the brand-new computer operating system. Accordingly, such a computer operating system is called <Zero Zone operating system>.

In <Zero Zone operating system>, the algorithm is provided so that the set of strictly defined units or physical quantities with different semantic dimensions can be calculated among each other, which has been deemed impossible. In other words, the system provides the function of converting physical quantities into numeric unit of simple quantity as well as the function of translating significant units with strict definitions.

Strong numeric interface of <Zero Zone operating system> innovates the existing input method and it allows the input of significant numbers based on Zero Zone code's compatibility between numbers and letters.

Therefore even laymen without computer knowledge can use the system and it is possible to expand the functions of computer systems in a way that complex computer calculation is quickly and precisely processed.

When compared with the concept of existing operating systems, <Zero Zone operating system> can be explained as follows; Language letters required for communications vary depending upon countries and peoples. For instance, Chinese is hieroglyphic characters that have meanings whereas Korean has the merit of both onomatopoeia and mimetic words.

This can be compared with various computer languages with certain individual functions. The function of language letter is further narrowed down so that Korean used in Seoul is adopted as the standard Korean among different Korean dialects throughout the nation. In this sense, to explain the concept of existing operating system, OS concept of Windows adopts a certain computer language to run computer system, which is the communications interface between people and nature. Thus, the OS has its own syntax that is the specific operating rule of the chosen computer language.

In order for a programmer to make the best use of application programs based on Windows O/S, he/she needs to have the good understanding of the specific computer language and the standard of the syntax rules. In contrast, <Zero Zone operating system> is not dependent on a specific computer language and it rather addresses the higher-level computer capacity itself, enhancing system functions.

As equations and metrology exist independently across different nations and peoples with different language letters, <Zero Zone operating system> is not restricted to any existing computer languages. It rather replaces all inputs with numbers that become algorithms as well as computer programs and computers are run, irrespective of computer languages.

This is related to the useful characteristic of the architecture of Zero Zone code's numbers and it is a newly expanded operating system at system level, i.e., the higher-level computer language.

Now, examples of <Zero Zone operating system> will be presented in further details. In following explanation, each process is executed by computer CPU.

<Zero Zone operating system> includes the algorithm of converting physical quantities into dimensionless numbers based on Zero Zone code, the industrial engineering calculation algorithm for physical quantities-turned dimensionless numbers, the quantitative and the qualitative translation algorithm of physical quantities input as dimensionless numbers or dimensionless numbers resulting from industrial engineering calculation and the algorithm of converting dimensionless numbers resulting from industrial engineering calculation back to physical quantities with units.

<Zero Zone operating system> is installed in computers where a record medium of Standard compilation code and Zero Zone code is loaded. Here, the record medium refers to all electronic media that are known to store data such as hard disks, flash memory, RAM, ROM, optic disks, disk arrays, etc.

Specifically, the aforementioned algorithm of dimensionless numbers includes the step of getting the physical quantities with units through user interface; and the step of substituting units with Zero Zone codes, conducting operations and converting physical quantities into dimensionless numbers. Preferably, the foregoing user interface is GUI.

Here, units above can be represented as fundamental units in <Metric system> or as the units derived from fundamental units. For the latter, it is desirable for the aforementioned algorithm of dimensionless numbers to include the step of converting derived units into fundamental units as well. And in the process of inserting Zero Zone code, if the unit attached to the concerned physical quantity is the combination of 2 or more basic units (e.g., m/s), Zero Zone code is input into each basic unit respectively. When there are 2 or more physical quantities input, the step of converting physical quantities into dimensionless numbers will obviously be repeated as many as the number of physical quantities.

The foregoing industrial engineering calculation algorithm includes the step of inserting the physical quantity-turned dimensionless number into the variable of the physical quantities in the industrial engineering equation; and the step of executing the industrial engineering operation and getting the result without the process of simplifying dimensions.

The industrial engineering equation here refers to overall equations derived from natural laws known for various industrial engineering applications. A case in point is the equation to compute the temperature in the system with specific conditions. The foregoing industrial engineering equation can be an equation that is pre-designated in <Zero Zone operating system> or the equation input from outside through user interface.

The aforementioned quantitative and qualitative translation algorithm uses physical quantities expressed as dimensionless numbers input from user interface or dimensionless numbers resulting from execution of industrial engineering operation algorithm. Then it executes the comparative operation of the quantized dimensionless numbers stored in Standard compilation code, identifies the exactly same dimensionless numbers or those with the smallest errors and produces output, i.e., nature's dynamic equations corresponding to the chosen dimensionless numbers. As the specific example of this step is mentioned earlier, explanation will not be given repeatedly.

The foregoing algorithm of converting dimensionless numbers back to physical quantities with units includes the step of identifying the type of pre-designated unit or designated by user interface; the step of converting dimensionless numbers produced from industrial engineering calculation based on Zero Zone code matching the unit back into the physical quantities with the specific units; and the step of producing the output of converted physical quantities through user interface.

Program designs will be much more simplified as <Zero Zone operating system> allows cross-calculation among physical quantities with different dimensions and immediately translates input numbers or calculation results when referring to Standard compilation code. In other words, <Zero Zone operating system> brings about an innovative computer operation, i.e., “input (conversion into numbers, number format)→output (structured language format, algorithm). Accordingly, we can enhance relative operation speed instead of typical physical processing speed and increasingly utilize the number of bits per unit area, reaping the effect of much better memory capacity. Calculation and control, the two functions of computers can be maximized, resulting in the leap of computer capacity.

Industrial engineering operation method, quantitative and qualitative translation method of dimensionless numbers and Zero Zone operating system that are presented in the present invention can be coded as program language and stored in a computer readable record medium. As for the record medium, there are ROM (Read Only Memory), RAM (Random Access Memory), CD-ROM (Compact Disk-Read Only Memory), DVD-ROM (Digital Video Disk-Read Only Memory), magnetic tape, floppy disk, optic data storage, flash memory and so on. And such record medium is stored in computer systems with network connectivity. Thus, it is possible to store and execute computer-readable codes in a distributed manner.

Therefore, even if the present invention is explained in the limited examples and drawings, it is not confined to what is presented here. Rather, the person having ordinary skill in the art can also diversely change or modify the invention within the scope of the present invention as defined in the appended claims.

### INDUSTRIAL APPLICABILITY

1. The optimization algorithm of Zero Zone code-driven measurement standard and <Zero Zone operating system> facilitate communications across different fields of science and will rapidly advance overall science and science-based industries.

2. <Zero Zone operating system> enables numbers themselves=equations=algorithm=computer programming language=computer programs so that computer science and computer engineering can be revolutionized. Numbers themselves become programming language. Thus, anyone can leverage this and become programmers. Arabic numerals (decimal system) are the operating system for measurement and calculation in natural science. Accordingly, even children can easily become programmers.

3. Due to the easy-to-use environment of user interface system software, anyone can understand and utilize computer systems. Computers currently use 256 types of bytes from combination of 8-9 bits based on bits that consist of binary signals of 0 and 1. These 256 types of bytes are respectively assigned to Alphabets and all and this is how programming language is developed and utilized. In other words, human beings arbitrarily defined and used bytes. However, the present invention has proposed an approach where dimensionless numbers discovered from nature's invariance equations are used to establish a byte-driven operating system. Therefore, various numeric data in the field of scientific technology can be quickly translated and understood.

4. Any computer companies do have the problem of incompatibility of computer programs due to different source codes across programs. This is also because computer companies arbitrarily defined source codes. Based on the proposal of the present invention, source codes are not arbitrarily defined. Rather, sources codes are set based on dimensionless numbers and if programming is done as such, huge volume of numeric data in the field of scientific technology can be easily and quickly processed. And at the same time, the meaning can be identified as well so that computers can be run without complex command structure.

5. One of the important challenges in artificial intelligence is to make machines understand natural languages that human beings use. For this end, the translation layer to map natural language to machine language is needed. For example, physical properties widely used in the areas of scientific technology are main subject of researches thereof. And if they are expressed as the combination of numbers and units to deliver the meaning, machines should be able to understand both numbers and their meaning. However, if we take the approach in the present invention, i.e., the representation of physical properties via dimensionless numbers based on invariance equations, numbers without units themselves can carry the data on the quantity and the meaning and in so doing, machines can understand the meaning via numbers alone.

6. As invariance equations are discovered, it is possible to unify units into one system of numbers. We can now express fundamental physical properties including physical quantities with unique numbers and unique numbers here work as if they are fundamental physical quantities. When this system is used for computer programming, we can facilitate complex and difficult operations in the fields of scientific technology.

7. Standard compilation code as per <Zero Zone theory> can lay the groundwork for expert system since the knowledge base converts the commonly designated physical quantities into numbers and accomplishes “the method of expressing facts”. That is, system becomes logical programming language itself.

8. <Zero Zone operating system> implements core technology of thinking computers. In other words, various experimental results (physical quantities) are stored in computers and computers think based on the most optimized solution that Standard compilation code dictates.

9. In <Zero Zone operating system>, number codes and letters codes (physical properties including physical quantities) are compatible. A specific physical property is the algorithm incorporating a certain physical quantity. E.g. 1) An efficient translation tool is provided regarding the collection of data about particular molecules (represented as the combination of specific physical quantities—related field: quantum chemistry). Thus, this directly offers important and decisive data for development of new medicines based on the structure and the function of particular enzymes related to diseases. E.g. 2) As major elements determining the attributes of metallic materials, parameters such as electron structure, content of impurities within crystals, temperature, volume, pressure, surface area, etc. are expressed as specific physical quantities and these elements are reviewed, if purity level of a certain metal is to be increased. <Zero Zone operating system> is highly useful to locate the algorithm to extract numeric values of physical quantities as the most optimized parameters. In terms of both examples 1) and 2), specific physical properties equal specific algorithms and conclusively they are designed to search numeric values that consist of specific parameters in computer database.

10. <Zero Zone operating system> transforms logical expressions with different semantic dimensions into arithmetic codes. In other words, energy's absolute scale is codified, regardless of algorithms. In reality, numbers are assigned (quantized) to the smallest computable objects, i.e., physical properties including physical quantities that serve as the basis of all scientific calculation. Thus, input and output are all in numbers. And the interpretation of these numbers is done via the specific comparative analysis with general translation of existing physical quantities. All this can be done via equivalence that is formed between physical quantities and numbers respectively.

11. As per <Zero Zone operating system>, numbers themselves are data as well as language (sentences), contributing to data compression. No special or complex command is needed here. Therefore, heterogeneous computer languages are turned into standard codes of numbers, allowing connectivity among them.

12. <Zero Zone operating system> can be used to visualize—quantify the conditions of natural phenomena that cannot be directly observed.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A method of executing industrial engineering operations via the conversion of measurement units into dimensionless numbers, comprising the steps of converting physical quantities with units of different dimensions into dimensionless numbers, and inserting the dimensionless numbers into industrial engineering equations for operation, in terms of operations of industrial engineering equations related to industrial engineering measurement and calculation or control.

2. The method of executing industrial engineering operations via the conversion of measurement units into dimensionless numbers according to claim 1, wherein the physical quantities are expressed as standard units in accordance with the Metric System, and
wherein the step of converting the physical quantities above into dimensionless numbers includes the step of substituting each unit included in the foregoing standard units for the corresponding Zero Zone codes to convert physical quantities into dimensionless numbers.

3. The method of executing industrial engineering operations via the conversion of measurement units into dimensionless numbers according to claim 1, wherein the step of converting the physical quantities above into dimensionless numbers includes the steps of converting the units of the foregoing physical quantities into the standard units of the Metric System; and substituting each unit included in the converted units for the corresponding Zero Zone codes to convert physical quantities into dimensionless numbers.

4. The method of executing industrial engineering operations via the conversion of measurement units into dimensionless numbers according to claim 1, further comprising the step of:
producing an output of the foregoing industrial engineering operations as dimensionless numbers.

5. The method of executing industrial engineering operations via the conversion of measurement units into dimensionless numbers according to claim 1, further comprising the step of:
converting dimensionless numbers resulting from the foregoing industrial engineering operations back into the physical quantities with units and producing the output accordingly.

6. The method of executing industrial engineering operations via the conversion of measurement units into dimensionless numbers according to claim 1, wherein the equations for industrial engineering operation contain physical constants, and
wherein the physical constants have dimensionless numbers as per the theorem of fundamental dimension.

7. The method of executing industrial engineering operations via the conversion of measurement units into dimensionless numbers according to claim 1, further comprising the steps of:
accessing Standard a compilation code in which quantized dimensionless numbers as the result of quantization of multiple dynamic equations that comply with Zero Zone theory and the corresponding equations are stored in a structure allowing cross-reference; and using dimensionless numbers derived from industrial engineering operations as the keys for searching one of an exactly identical dimensionless number or those with the smallest errors from the dimensionless numbers of the Standard compilation code, extracting dynamic equations that match the resulting dimensionless numbers from the Standard compilation code and producing output accordingly.

8. A computer-readable record medium that stores programs for executing the method defined in claim 1.

9. A method of executing industrial engineering operations via the conversion of measurement units into dimensionless numbers according to claim 7, comprising the steps of:
(a) loading industrial engineering equations;
(b) getting input of physical quantities with units concerning variables contained in the industrial engineering equations;
(c) substituting the unit of physical quantity entered above for dimensionless number in accordance with the Zero Zone code and subsequently converting the physical quantity into dimensionless number; and
(d) inserting the dimensionless number converted from the physical quantity in the foregoing industrial engineering equations and executing the industrial engineering operations.

10. A method of executing industrial engineering operations via the conversion of measurement units into dimensionless numbers, comprising the steps of:
(a) loading industrial engineering equations;
(b) getting input of physical quantities with units concerning variables contained in the industrial engineering equations; and
(e) inserting the physical quantity indicated as dimensionless number in the foregoing industrial engineering equations and executing the industrial engineering operations.

11. The method of executing industrial engineering operations via the conversion of measurement units into dimensionless numbers according to claim 9, wherein the foregoing physical quantities are expressed as standard units in accordance with the Metric system, and
wherein the step of converting the foregoing physical quantities into dimensionless numbers includes the step of substituting each unit contained in the standard units above for a corresponding Zero Zone code to subsequently convert the physical quantities into dimensionless numbers.

12. The method of executing industrial engineering operations via the conversion of measurement units into dimensionless numbers according to claim 9, wherein the step of converting the foregoing physical quantities into dimensionless numbers includes the steps of converting the units of the physical quantities into standard units in accordance with the Metric system; and substituting each unit contained in the converted units for the corresponding Zero Zone code to subsequently convert the physical quantities into dimensionless numbers.

13. The method of executing industrial engineering operations via the conversion of measurement units into dimensionless numbers according to claim 9, further comprising the step of:
producing output of the foregoing industrial engineering operations as dimensionless numbers.

14. The method of executing industrial engineering operations via the conversion of measurement units into dimensionless numbers according to claim 9, further comprising the step of:
converting the dimensionless number resulting from the foregoing industrial engineering operations back into the physical quantity with unit.

15. The method of executing industrial engineering operations via the conversion of measurement units into dimensionless numbers according to claim 9, wherein the calculation equation for the industrial engineering operation contains physical constants, and
wherein the foregoing physical constants have dimensionless numbers as per the theorem of fundamental dimension.

16. The method of executing industrial engineering operations via the conversion of measurement units into dimensionless numbers according to claim 9, further comprising the steps of:
accessing the Standard compilation code in which quantized dimensionless numbers as the result of quantization of multiple dynamic equations that comply with Zero Zone theory and the corresponding equations are stored in a structure allowing cross-reference; and
using dimensionless numbers derived from the industrial engineering operations as the keys for searching the exactly identical dimensionless number or those with the smallest errors from dimensionless numbers of the aforementioned Standard compilation code, extracting dynamic equations that match the resulting dimensionless numbers above from Standard compilation code and producing output accordingly.

17. A computer-readable record medium that stores programs for executing the method defined in claim 9.

18. A method of establishing a Standard compilation code comprising the steps of:
getting input of dimensionless numbers as per the theorem of fundamental dimension in Zero Zone theory and the corresponding dynamic equations of nature;
(a) executing mathematical operations of regular patterns on the foregoing dimensionless numbers and quantizing the dimensionless numbers into multiple numbers;
(b) storing quantized numbers, mathematical operation methods that are deployed for the derivation of quantized numbers and reference codes of nature's dynamic equation in a way that cross-reference with quantized numbers is allowed; and
(c) repeatedly executing the steps (a) to (c) on multiple dimensionless numbers and the corresponding dynamic equations of nature.

19. A method of establishing a Standard compilation code according to claim 18, further comprising the steps of:
getting input of multiple dimensionless numbers as per the theorem of fundamental dimension in Zero Zone theory and of multiple dynamic equations of nature that match each dimensionless numbers; and
permutating and combining the multiple dimensionless numbers entered and executing operations on dimensionless numbers with pre-defined operators,
wherein, the foregoing steps (b) and (e) are executed on dimensionless numbers as the result of mathematical operation and the corresponding dynamic equations of nature.

20. A method of establishing a Standard compilation code, comprising the steps of:
(a) getting input of dimensionless numbers as per a theorem of fundamental dimension in Zero Zone theory and of the corresponding dynamic equations;
(b) executing a mathematical operation of regular patterns on the dimensionless numbers and quantizing the dimensionless numbers into multiple quantized numbers;
(c) storing the quantized numbers, the mathematical operation methods deployed for the derivation of quantized numbers and a reference codes of nature's dynamic equation in a way that cross-reference with quantized numbers is allowed; and
(d) repeatedly executing the steps (a) to (c) on multiple dimensionless numbers and the corresponding dynamic equations of nature.

21. The method of establishing a Standard compilation code according to claim 20, further comprising the steps of:
getting input of multiple dimensionless numbers as per the theorem of fundamental dimension in Zero Zone theory and of multiple dynamic equations of nature that match each dimensionless numbers; and
permutating and combining multiple dimensionless numbers entered and executing operations on the dimensionless numbers with pre-defined operators, wherein, the steps (b) and (c) are executed on the dimensionless numbers as the result of the mathematical operation and the corresponding dynamic equations of nature.

22. A method of establishing a Standard compilation code, comprising the steps of:
(a) getting input of dimensionless numbers in accordance with the theorem of fundamental dimension in Zero Zone theory and the corresponding dynamic equations of nature;
(b) executing mathematical operation of regular patterns on the foregoing dimensionless numbers and quantizing the dimensionless numbers into multiple numbers;
(c) storing the quantized numbers and corresponding dynamic equations of nature in a way that cross-reference is allowed; and
(d) repeatedly executing the steps (a) to (c) on multiple dimensionless numbers and the corresponding dynamic equations of nature.

23. The method of establishing a Standard compilation code according to claim 22, further comprising:
getting input of multiple dimensionless numbers in accordance with the theorem of fundamental dimension in Zero Zone theory and of multiple dynamic equations of nature that match each of the dimensionless numbers; and
permutating and combining the multiple dimensionless numbers entered and executing operations on dimensionless numbers with pre-designated operators,
wherein, the foregoing steps (b) and (c) are executed on the dimensionless numbers as the result of mathematical operation and the corresponding dynamic equations of nature.

24. A computer-readable record medium that stores programs for executing the method defined in claim 18.

25. A computer-readable record medium that stores a multiple of dimensionless numbers, generated from the quantization of multiple dimensionless numbers in accordance with the theorem of fundamental dimension in Zero Zone theory and nature's dynamic equations that are equivalent to the foregoing dimensionless numbers in a way that cross-reference is allowed.

26. A method of quantitative and qualitative translation of dimensionless numbers, using a computer-readable record medium that stores dimensionless numbers generated from the quantization of multiple dimensionless numbers in accordance with the theorem of fundamental dimension in Zero Zone theory and nature's dynamic equations that are equivalent to the foregoing dimensionless numbers in a way that cross-reference is allowed, the method comprising the steps of:
(a) getting input of physical quantities related to natural phenomena as dimensionless numbers;
(b) comparing the quantized dimensionless numbers stored in the record medium with the dimensionless numbers entered above and identifying the exactly same quantized dimensionless number or that with the smallest error; and
(c) reading the nature's dynamic equation that matches the chosen dimensionless number and producing an output accordingly.

27. The method of quantitative and qualitative translation of dimensionless numbers according to claim 26, further comprising the steps of:
(d) designating the error as a search key;
(e) comparing quantized dimensionless numbers stored in the record medium with the search key values and identifying the exactly same quantized dimensionless number or that with the smallest error as a function of the search key; and
(f) extracting the nature's dynamic equation that matches the chosen dimensionless number from the record medium, combining it with the dynamic equation read in the step (c) and producing output accordingly.

28. A computer-readable record medium that stores dimensionless numbers, generated from the quantization of multiple dimensionless numbers in accordance with the theorem of fundamental dimension in Zero Zone theory, the reference codes of nature's dynamic equations that match the dimensionless numbers and mathematical operators that establish the equivalence between the dimensionless numbers and the dynamic equations in a way that cross-reference is allowed

29. A method of quantitative and qualitative translation of dimensionless numbers, using a computer-readable record medium that stores dimensionless numbers generated from the quantization of multiple dimensionless numbers in accordance with a theorem of fundamental dimension in Zero Zone theory, the reference codes of nature's dynamic equations that match the dimensionless numbers above and mathematical operators that establish the equivalence between dimensionless numbers and dynamic equations in a way that cross-reference is allowed, the method comprising the steps of:
(a) getting an input of physical quantities related to natural phenomena as dimensionless numbers;
(b) comparing the quantized dimensionless numbers stored in the record medium with the dimensionless numbers and identifying quantized dimensionless number which is exactly the same as the dimensionless number or that with the smallest error; and
(c) reading the reference code and the mathematical operators of the nature's dynamic equation that matches the chosen dimensionless number from the record medium, and subsequently applying the mathematical operations to the reference code and producing an output.

30. The method of quantitative and qualitative translation of dimensionless numbers according to claim 29, further comprising the steps of:
(d) designating the foregoing error as a search key;
(e) comparing the quantized dimensionless numbers stored in the record medium with value of the search key and identifying the exactly same quantized dimensionless number or that with the smallest error;
(f) reading the reference code and the mathematical operators of the nature's dynamic equation that matches the chosen dimensionless number from record medium and applying mathematical operators to the reference code of the dynamic equation; and
(g) combining the reference code of dynamic equation with the mathematical operator from the step (e) with that of the equation with the mathematical operator from the step (f) and producing an output accordingly.

31. A computer-readable record medium that stores dimensionless numbers, generated from the quantization of multiple dimensionless numbers in accordance with a theorem of fundamental dimension in Zero Zone theory, dynamic equations that match the dimensionless numbers and mathematical operators that establish the equivalence between dimensionless numbers and dynamic equations in a way that cross-reference is allowed.

32. A method of quantitative and qualitative translation of dimensionless numbers, according to claim 9, using a computer-readable record medium that stores dimensionless numbers generated from a quantization of multiple dimensionless numbers in accordance with a theorem of fundamental dimension in Zero Zone theory, dynamic equations that match the dimensionless numbers and mathematical operators that establish the equivalence between dimensionless numbers and dynamic equations in a way that cross-reference is allowed, the method comprising the steps of:
(a) getting an input of physical quantities related to natural phenomena as dimensionless numbers;
(b) comparing the quantized dimensionless numbers stored in the record medium with the dimensionless numbers and identifying the exactly same quantized dimensionless number or that with the smallest error; and
(c) reading the nature's dynamic equation that matches the chosen dimensionless number and the mathematical operators thereof, and subsequently executing mathematical operations on the dynamic equations and producing an output accordingly.

33. The method of quantitative and qualitative translation of dimensionless numbers according to claim 29, further comprising the steps of:
(d) designating the foregoing error as a search key;
(e) comparing quantized dimensionless numbers stored in the record medium above with a value of the search key and identifying the exactly same quantized dimensionless number or that with the smallest error;
(f) reading the nature's dynamic equation that matches the chosen dimensionless number and the mathematical operators thereof from record medium and applying the mathematical operators to the dynamic equation; and
(g) combining the dynamic equation where the mathematical operator from step (c) is applied with an equation where the mathematical operator from step (f) above is applied and an producing output accordingly.

34. A computer-readable record medium that stores programs for executing the method defined in claim 26.
